(19) United States
(12) Patent Application Publication
(10) Pub. No.: US 2023/0286865 A1
(43) Pub. Date: Sep. 14, 2023

(54) COMPOSITION COMPRISING A BINDER AND BIO-BASED AGGREGATES AND THE BINDER THEROF

(71) Applicant: Material Research Ltd [GB/GB], Corton Denham Sherborne, Dorset (GB)

(72) Inventor: Robert Michael Heathcote LAWRENCE, Dorset (GB)

(21) Appl. No.: 18/019,569

(22) PCT Filed: Jul. 29, 2021
(86) PCT No.: PCT/GB2021/051962

§ 371 Date: Feb. 3, 2023

(30) Foreign Application Priority Data
Aug. 4, 2020 (GB) 2012111.7

(51) Int. Cl. C04B 28/26; C04B 18/24; C04B 24/04; C04B 22/06; C04B 24/16; C04B 40/00; C04B 40/02; B32B 5/02; B32B 9/00; B32B 9/06; B32B 9/04

(52) U.S. Cl. CPC C04B 28/26; C04B 18/248; C04B 24/045; C04B 22/068; C04B 24/16; C04B 40/006; C04B 40/0231; C04B 40/0263; C04B 40/0259; B32B 5/022; B32B 5/024; B32B 9/005; B32B 9/06; B32B 9/047; C04B 2111/00017

(57) ABSTRACT

This invention relates to a biodegradable composition comprising a low carbon footprint binder comprising a silicate, and bio-based aggregates. The invention also relates to the binder thereof, products, including insulation material and wall boards/panels, formed from the binder and the composition, a method of preparing the binder and composition and/or the products, and a method of using the binder and composition and/or the products in construction.

### TECHNICAL FIELD

This invention relates to a biodegradable composition comprising a low carbon footprint binder and bio-based aggregates. The invention also relates to the binder thereof, products, including insulation material and wall boards/panels formed from the binder and the composition, a method of preparing the binder and composition and/or the products, and a method of using the binder and composition and/or the products in construction.

### BACKGROUND

Concrete is ubiquitous in the construction industry. A major component of concrete is cement and the cement industry is responsible for creating up to 8% of worldwide man-made emissions of carbon dioxide (50% from the chemical process, and 40% from burning fossil fuels). The carbon dioxide produced for the manufacture of structural concrete (using ˜14% cement) is estimated at 410 kg/m³ (˜180 kg/tonne @ density of 2.3 g/cm³).

The EU directive (EU) 2018/844 sets goals to reduce greenhouse gas emission levels by 40% by the year 2030. In view of the dire environmental credentials of concrete, recently alternatives have been proposed as alternatives to the material in various aspects of construction, these alternatives include straw bales, rammed earth floors, recycled plastics and, perhaps most importantly, hemp-lime insulation, commercially known as Hempcrete®.

Hemp-lime is a composite material most commonly formed of hemp shiv, the woody core of the hemp plant, and a lime binder and water.

Hemp-lime insulation has been used since the 1980s as a breathable, low environmental-impact insulation material. However, while hemp-lime has many advantages over concrete, there is a conflict between thermal and mechanical performance in that in order to achieve acceptably low thermal conductivity, the amount of binder used is insufficient to create a material that is sufficiently robust to be machined or even handled roughly.

Furthermore, traditional hemp-lime requires a large amount of excess water in the initial mixing and casting stage, and if allowed to dry naturally, this can take up to two years to stabilise. A forced-air drying technique has been developed by at least one manufacturer (Greencore®) to speed up this process, but the material remains insufficiently robust to be machined.

In addition, the carbon footprint of hemp-lime is adversely affected by the energy cost inherent in manufacturing the lime binder.

Research has been ongoing into replacing the lime binder with other binders including cement, clay, and thermosetting polymers. The most promising of these are the thermosetting polymers such as those developed in the ISOBIO project (www.isobioproject.corn). These binders are capable of being manufactured on continuous production lines producing relatively thin (up to 75 mm) panels. The resultant material is sufficiently robust to be machined. This approach however requires a heavy investment in plant and equipment, and is not ideally suited to the manufacture of thicker (up to 150 mm thick) elements. The carbon footprint of this material is also adversely impacted by the need for high temperatures in the manufacturing process.

Thus, there remains a need to find a suitable, environmentally-friendly, binder to replace the lime binder in hemp-lime that provides a final composition that is more robust than ‘traditional’ hemp-lime, and/or does not require the extensive drying and curing times associated with hemp-lime.

Silicate binders, for example sodium silicate are inorganic materials that has a low carbon footprint. Silicates tend to have a good environmental profile, for example, aqueous sodium silicate is defined as readily degradable in the environment and has no bioaccumulative potential (Fischer Scientific Safety Data Sheet for sodium Silicate 37%; https://beta-static.fishersci.com/content/dam/fishersci/en_US/documents/programs/education/regulatory-documents/sds/chemicals/chemicals-s/S25566.pdf; accessed 30 Jul. 2020).

Sodium silicate, in particular, has previously found use in various aspects of the construction industry.

Along with a range of other chemicals, sodium silicate combined with an alkali activator such as sodium hydroxide have been used for the last 50 years to create geopolymers (https://www.geopolymer.org/fichiers_pdf/30YearsGEOP.pdf; accessed 30 Jul. 2020). When combined with aggregates and waste materials such as ground granulated Blast Furnace Slag (GGBFS) or Fly Ash they are used to make lower carbon concrete substitutes. Geopolymers as a material were conceived by Davidovits in the 1970s (Davidovits, Joseph (2008). Geopolymer Chemistry and Applications. Saint Quentin, France: Geopolymer Institute.) Addition of sodium silicate to kaolinite bearing clays, activated with sodium hydroxide (alkali activation) created zeolites which bind the clay to form strong bricks. (Diop, M. B., Grutzeck, M. W. Sodium silicate activated clay brick. Bull Eng Geol Environ 67, 499-505 (2008))

Mortars made from a mixture of sand, clay and sodium silicate produced high bond strengths in clay brick walls. Compressive strengths of the mortars were typically 9.5 MPa. (Development of a novelmortar for use with unfired clay bricks. Mike Lawrence, Andrew Heath, and Pete Walker. Proceedings of the Institution of Civil Engineers—Construction Materials 2013 166:1, 18-26) Sodium silicate has also been used since the late 19^{th} century to bond casting sand by passing CO₂ through sand wetted with sodium silicate to produce sodium carbonate which effectively bonds the particles of sand together. This is further strengthened when the material dries out. (R G Liptai; An experimental study of the effects of additives on the collapsibility of carbon dioxide-sodium silicate bonded foundry cores; Masters Thesis, University of Missouri)

Furthermore, sodium silicate has been used as an additive to lime mortars at a rate of 5%-10% (w/w). This was shown to marginally improve mechanical properties. (Sinka, M., Radina, L., Sahmenko, G., Korjakins, A., & Bajare, D. (2015). Enhancement of lime-hemp concrete properties using different manufacturing technologies. Academic Journal of Civil Engineering, 33(2), 301-308.)

Sodium silicate is also used by Steico® as an adhesive to produce multi-layered insulation boards.

To date, inorganic silicates, for example, sodium silicate has not previously been considered as a primary binder, in particular, with bio-based aggregates.

### SUMMARY OF INVENTION

In a first aspect, the invention provides a composition comprising:
a. a binder comprising a silicate; and
b. a bio-aggregate;
   wherein the binder comprises at least 50% by weight of the silicate, based on the total weight of the binder.

In embodiments, the silicate is selected from the group consisting of: sodium silicate; potassium silicate and combinations thereof. Suitably, the silicate is sodium silicate.

In embodiments, the bio-aggregate is selected from the group consisting of: hemp shiv flax shiv; chopped sunflower stalk; chopped cereal straw; cork particles; corn cob particles; wood chip and mixtures thereof. Suitably, the bio-aggregate is hemp shiv.

In embodiments, the binder is present in the composition in an amount of from 5% to 95% by weight and the bio-aggregate is present in an amount of from 95% to 5% by weight, based on the total weight of the composition. Suitably, the binder is present in the composition in an amount of from 30% to 70% by weight and the bio-aggregate is present in an amount of from 70% to 30% by weight, based on the total weight of the composition.

Suitably, the composition consists essentially of the binder and the bio-aggregate. Suitably, the composition consists of the binder and the bio-aggregate. All compositions may contain minor amounts (<15 wt %, suitably <10 wt %, suitably <5 wt %, based on the total weight of the composition) of residual or entrained water.

In embodiments, the binder comprises at least 70% by weight of the silicate, based on the total weight of the binder. Suitably, the binder comprises at least 85% by weight of the silicate, based on the total weight of the binder. For the avoidance of doubt, the weight percentages of these embodiments refer to the dry weight of the silicate in the binder only. The weight percentages do not refer to that of the composition as a whole, including the bio-aggregate and/or other additives.

In embodiments, the binder further comprises a reactant that chemically reacts with the silicate. Suitably, the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate (Triacetin). Suitably, the reactant is ethyl acetate or glycerol triacetate. Suitably, the reactant is glycerol triacetate. Suitably, the binder comprises between 0.5 to 20% by weight reactant, based on the total weight of the binder. Suitably, the silicate and the reactant are present in the binder in a weight ratio of from approximately 100:3 to approximately 100:15, more suitably, a weight ratio of approximately 100:7.5.

In embodiments, the binder comprises at least 70% by combined weight of the silicate and the reactant, based on the total weight of the binder. Suitably, the binder comprises at least 85% by combined weight of the silicate and the reactant, based on the total weight of the binder. For the avoidance of doubt, the weight percentages of these embodiments refer to the total dry weight of: the silicate, the reactant, and any product from the reaction of the silicate and the reactant, in the binder only. The weight percentages do not refer to that of the composition as a whole, including the bio-aggregate and/or other additives.

Suitably, the binder consists essentially of the silicate and the reactant. Suitably, the binder consists of the silicate and the reactant. The binder may contain minor amounts (<15 wt %, suitably <10 wt %, suitably <5 wt %, based on the total weight of the composition) of residual or entrained water.

In embodiments, the binder further comprises a component selected from the group consisting of: one or more surfactants; one or more oxidising agents and mixtures thereof. These components are added to the binder to (1) cause the binder to foam, thereby increasing its volume and reducing its density and thermal conductivity, and (2) accelerating the setting of the binder. Suitably, the oxidising agent is hydrogen peroxide. Suitably the binder comprises between 0.5 to 15% by weight oxidising agent, based on the total weight of the binder. Suitably, the surfactant is alkyl sulfonate or other surfactants that are compatible with alkaline environments, or commercially available surfactants such as Sika® AER5. Suitably, the binder comprises between 1 to 10% by weight surfactant, based on the total weight of the binder, suitably 4% by weight surfactant, based on the total weight of the binder.

In embodiments, the silicate, the reactant, the oxidising agent and the surfactant in a weight ratio of from approximately 100:5:0.5:1 to approximately 100:15:15:10 respectively, more suitably in a weight ratio of approximately 100:7.5:2.5:4 respectively.

In embodiments, the composition comprises between 0.1 to 20 wt % of one or more further additives, based on the total weight of the composition. Suitably, the additives are selected from the group consisting of: zinc oxide; calcium carbonate or mixtures thereof.

In embodiments, the binder or composition is biodegradable. In further embodiments, the binder has a carbon footprint of less than 20 kg CO₂e per cubic metre of the composition.

In a second aspect, the invention provides a composition comprising:
a. a binder comprising sodium silicate and a reactant selected from the group consisting of ethyl acetate and glycerol triacetate; and
b. a bio-aggregate;
   wherein the binder comprises at least 50% by weight of the silicate, based on the total weight of the binder. Suitably the reactant is glycerol triacetate.

In a third aspect, the invention provides a composition comprising:
a. a binder comprising:
   i. a silicate;
   ii. a reactant;
   iii. an oxidising agent;
   iv. a surfactant; and
b. a bio-aggregate;
   wherein the binder comprises at least 50% by weight of the silicate, based on the total weight of the binder. Suitably, the silicate, the reactant, the oxidising agent and the surfactant are present in the composition in a weight ratio of approximately 100:7.5:2.5:4 respectively. Suitably, the silicate is sodium silicate, the reactant is ethyl acetate or glycerol triacetate, the oxidising agent is hydrogen peroxide, and/or the surfactant is alkyl sulfonate.

In a fourth aspect, the invention provides a silicate binder, wherein the binder comprises at least 50% by weight of a silicate based on the total weight of the binder. Suitably, the silicate binder of the fourth aspect of the invention is for use in, or suitable for use in, the composition of the first, second and third aspect of the present invention.

In embodiments, the binder comprises at least 70% by weight of the silicate, based on the total weight of the binder. Suitably, the binder comprises at least 85% by weight of the silicate, based on the total weight of the binder. For the avoidance of doubt, the weight percentages of these embodiments refer to the dry weight of the silicate in the binder only. The weight percentages do not refer to that of the composition as a whole, including the bio-aggregate and/or other additives.

In embodiments, the binder further comprises:
a. a reactant;
b. an oxidising agent; and/or
c. a surfactant.

In embodiments, the silicate is sodium silicate; the reactant is ethyl acetate or glycerol triacetate; the oxidising agent is hydrogen peroxide; and/or the surfactant is Sika® AER5 or alkyl sulfonate.

In embodiments, the binder is as otherwise herein described in respect of any embodiment of the composition of the first, second and third aspect of the present invention, without the bio-aggregate. In other words, in embodiments, the silicate binder of the fourth aspect of the invention is suitable for use in, but may be considered a material that is separate or distinct from, the composition comprising a bio-aggregate of the first, second and third aspects of the present invention.

In a fifth aspect, the invention provides a product comprising:
a. The binder of the fourth aspect; and
b. A reinforcement component;

In embodiments, the product is a lightweight insulating board product.

In embodiments, the reinforcement component is selected from the group consisting of: woven and non-woven fibres, a mesh sheet, rods. Suitably the reinforcement component a render mesh reinforcement sheet. In embodiments the reinforcement component is embedded within and/or is on the surface of the product.

In embodiments, the product further comprises:
c. Lining on at least one face of the product.

Suitably, the lining is formed of paper, suitably 800-1600 gsm paper, suitably 1000-1400 gsm paper, suitably 1000 gsm paper. Suitably, the paper lining is on at least two faces of the insulating board product.

In embodiments, the product comprises one or more layers of binder. Suitably each layer of binder may be of the same of differing proportions of constituent parts. Suitably the layers of binder of each in accordance with the present invention. In other embodiments, at least one of the layers comprises a binder in accordance with the present invention.

In embodiments, the board product further comprises bio-aggregate, suitably up to 50 wt %, 40 wt %, 30 wt %, 20 wt % or up to 10 wt % bio-aggregate, based on the total weight of the product.

In embodiments, the oxidising agent is present in an amount of approximately 0.5 wt % to approximately 5 wt %, based on the total weight of the binder.

In a sixth aspect, the invention provides a method of preparing the composition of the first, second or third aspects of the invention, said method comprising the steps of:
a. combining a binder comprising a silicate and a bio-aggregate to provide a slurry;
b. mixing the slurry to provide a mixture;
c. allowing the mixture to set to provide the set composition;
   wherein the binder comprises at least 50% by weight of the silicate, based on the total weight of the binder.

In embodiments of the sixth aspect of the invention, the silicate is selected from the group consisting of: sodium silicate; potassium silicate and combinations thereof. Suitably, the silicate is sodium silicate. Suitably, the bio-aggregate is selected from the group consisting of: hemp shiv flax shiv; chopped sunflower stalk; chopped cereal straw; cork particles; corn cob particles; wood chip and mixtures thereof. Suitably, the bio-aggregate is hemp shiv.

In embodiments, the binder is present in an amount of from 5% to 95% by weight and the bio-aggregate is present in an amount of from 95% to 5% by weight, based on the total weight of the composition. Suitably, the binder is present in the composition in an amount of from 30% to 70% by weight and the bio-aggregate is present in an amount of from 70% to 30% by weight, based on the total weight of the composition.

In embodiments, the binder comprises at least 70% by weight of the silicate, based on the total weight of the binder. Suitably, the binder comprises at least 85% by weight of the silicate, based on the total weight of the binder. For the avoidance of doubt, the weight percentages of these embodiments refer to the dry weight of the silicate in the binder only. The weight percentages do not refer to that of the composition as a whole, including the bio-aggregate and/or other additives.

In embodiments, the binder further comprises a reactant. Suitably, the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate (Triacetin). Suitably, the reactant is ethyl acetate or glycerol triacetate. Suitably, the reactant is glycerol triacetate. Suitably, the binder comprises between 0.5 to 20% by weight reactant, based on the total weight of the binder.

In embodiments, the binder comprises at least 70% by weight of the silicate and the reactant, based on the total weight of the binder. Suitably, the binder comprises at least 85% by weight of the silicate and the reactant, based on the total weight of the binder. For the avoidance of doubt, the weight percentages of these embodiments refer to the total dry weight of: the silicate, the reactant, and any product from the reaction of the silicate and the reactant, in the binder only. The weight percentages do not refer to that of the composition as a whole, including the bio-aggregate and/or other additives.

In embodiments, the binder further comprises a component selected from the group consisting of: one or more surfactants; one or more oxidising agents and mixtures thereof. These components are added to the binder to (1) cause the binder to foam, thereby increasing its volume and reducing its density and thermal conductivity, and (2) accelerating the setting of the binder. Suitably, the oxidising agent is hydrogen peroxide. Suitably the binder comprises between 0.5 to 15% by weight oxidising agent, based on the total weight of the binder. Suitably, the surfactant is alkyl sulfonate or other surfactants that are compatible with alkaline environments, or commercially available surfactants such as Sika® AER5. Suitably, the binder comprises between 1 to 10% by weight surfactant, based on the total weight of the binder, suitably 4% by weight surfactant, based on the total weight of the binder.

In embodiments, the setting step (c) is complete within 10 minutes to 8 hours at normal room temperatures (for example, from approximately 18° C. to approximately 23° C.).

In embodiments, after step (c), there is step (d) de-watering the set composition to provide the composition. Suitably, in this embodiment, and in other aspects and embodiments disclosed herein, the de-watering may be by equilibration of moisture content of the composition with the ambient or surrounding air. Alternatively. The de-watering may be forced using a method selected from: heating; applying reduced pressure; passing gases through or adjacent the material; and combination thereof. Suitably, the de-watering in step (d) is by forcing air through the composition.

In embodiments, the drying in step (d) is by forcing air through the composition. Suitably, drying is complete within 12 hours to 48 hours at ambient temperature.

In embodiments, carbon dioxide, or one or more other carbonation agents, is fed to the composition during drying. In further embodiments, after drying the composition is cured at elevated temperature (i.e. a temperature above ambient temperature). Suitably, the elevated temperature is between 80° C. to 200° C.

In embodiments, the mixture is compressed prior to, or during setting. Suitably, the mixture is compressed at a pressure of between 200 kPa to 500 kPa. In embodiments the mixture is compressed for between approximately 1 minute up to approximately 8 hours. Suitably compression is only required during the duration of setting, after which the compression may be removed. In embodiments, products, such as blocks, may be formed by an automated process which compresses for less than 1 minute prior to de-moulding of the mixture for setting.

In a seventh aspect, the invention provides a method of preparing the silicate binder of the fourth aspect, said method comprising the steps of:
a. providing a binder comprising a silicate as a slurry;
b. mixing the slurry to provide a mixture;
c. allowing the mixture to set to provide the silicate binder.
   wherein the binder comprises at least 50% by weight of the silicate, based on the total weight of the binder.

In embodiments, the silicate is selected from the group consisting of: sodium silicate potassium silicate and combinations thereof. Suitably, the silicate is sodium silicate.

In embodiments, the binder further comprises a reactant that chemically reacts with the silicate. Suitably, the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate. Suitably, the reactant is ethyl acetate or glycerol triacetate. Suitably, the binder comprises between 0.5 to 20% by weight of the reactant, based on the total weight of the binder.

In embodiments, the binder comprises at least 70% by weight of the silicate and the reactant, based on the total weight of the binder. In embodiments, the binder comprises at least 85% by weight of the silicate and the reactant, based on the total weight of the binder.

In embodiments, the binder further comprises an oxidising agent. Suitably, the oxidising agent is hydrogen peroxide. Suitably, the binder comprises between 0.5 to 15 wt % of one or more of the oxidising agent, based on the total weight of the binder.

In embodiments, the binder further comprises a surfactant. In embodiments, the surfactant is selected from the group consisting of: Sika® AER5 and alkyl sulfonate. Suitably, the binder comprises between 1 to 10 wt % of one or more of the surfactant, based on the total weight of the binder.

In embodiments, after step (c) the method comprises:
d. de-watering the silicate binder.

In an eighth aspect, the invention provides a product formed of, or comprising, the composition of the first, second or third aspect of the invention, the silicate binder of the fourth aspect, or by the method of the sixth or seventh aspect of the invention.

In embodiments, the product is selected from the group consisting of: insulation block; insulation panel; sheet material; board; and cladding.

In embodiments, the product has an outer layer of sheet material on at least one surface. Suitably, the outer layer of sheet material is on at least two opposing sides of the product. Suitably, the sheet material is selected from the group consisting of: paper; hessian; cloth; woven fabric; non-woven fabric; and bio-based mesh.

In a ninth aspect, the invention provides use of the composition of the first, second or third aspect of the invention, the silicate binder of the fourth aspect, or the product of the sixth or seventh aspect of the invention in construction.

In a tenth aspect, the invention provides use of the composition of the first, second or third aspect of the invention or the product of the sixth or seventh aspect of the invention as an insulation material.

In an eleventh aspect, the invention provides use of the composition of the first, second or third aspect of the invention or the product of the sixth or seventh aspect of the invention as an insulation block.

In a twelfth aspect, the invention provides use of the composition of the first, second or third aspect of the invention or the product of the sixth or seventh aspect of the invention as a wall board. Suitably, the wall board is selected from the group consisting of: a render carrier; and plasterboard.

### BRIEF DESCRIPTION OF THE DRAWINGS

One or more embodiments of the invention will now be described, by way of example only, with reference to the accompanying drawings, in which:

FIG. 1 show images of (a) 22 mm and (b) 3 mm Hembuild® hemp shiv supplied by East Yorkshire Hemp Ltd®; a bio-aggregate used in an exemplified embodiment of the invention.

FIG. 2 shows a drying apparatus (a) without; and (b) with an extraction hood fitted.

FIG. 3 shows material formed of the biodegradable composition in accordance with embodiments of the present invention after drying in the apparatus of FIG. 2. (a) shows a perspective view of a block; (b) shows a close-up image of a face of the block; (c) is a perspective view of a 50 mm thick sheet of the composition in accordance with the present invention; (d) shows the edge of the sheet of (c); (e) shows a board product formed of a composition of the present invention that may be suitable for use as a render carrier. This embodiment uses 20 mm shiv and is 20 mm thick having been compressed with a load of 200 kPa until set; (f shows the surface of the board product of (e); (g) shows a paper-lined tapered embodiment of the composition of the present invention which may be used as a plasterboard. This embodiment uses 3 mm shiv and is 12.5 mm thick having been compressed with a load of 400 kPa until set; (h) shows a cross-section through the board of (g) showing a thin (<3 mm) layer of foamed pure binder between the paper covering and the composition which aids retention of a smooth external surface.

FIG. 4 shows a typical compressive response for compositions in accordance with the present invention.

FIG. 5 shows the variation of thermal conductivity with mean temperature for compositions in accordance with the present invention.

FIG. 6 shows typical flexural response for panels formed of compositions in accordance with the present invention.

FIG. 7 shows the variation of thermal conductivity with mean temperature for each panels formed of compositions in accordance with the present invention.

FIG. 8 shows the uniaxial testing frame used to determine the compressive behaviour of the materials according to the invention according to EN 826:2013.

FIG. 9 shows Instron 3369 uniaxial testing frame used to determine the flexural behaviour of panels according to the present invention according to EN 310:1993.

FIG. 10 shows hemp-silicate composition without reactant in accordance with the present invention placed in the mould.

FIG. 11 shows the demoulded hemp-silicate composition without reactant in accordance with the present invention.

FIG. 12 shows a demoulded hemp-silicate composition without reactant in accordance with the present invention after 24 hours of forced air drying.

### DEFINITIONS

For convenience, before further description of the present disclosure, certain terms employed in the specification, and examples, are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles ‘a’, ‘an’ and ‘the’ are used to refer to one or to more than one (i.e. to at least one) of the grammatical object of the article.

As used herein, the term ‘comprising’ means any of the recited elements are necessarily included and other elements may optionally be included as well. ‘Consisting essentially of’ means any recited elements are necessarily included, elements which would materially affect the basic and novel characteristics of the listed elements are excluded, and other elements may optionally be included. ‘Consisting of’ means that all elements other than those listed are excluded. Embodiments defined by each of these terms are within the scope of this invention. The term ‘comprising’, when used in respect of certain components of the composition, should be understood to provide explicit literal basis for the term ‘consisting essentially of’ and ‘consisting of’ those same components.

The weight percentages of the binder or composition of the present invention provided herein, unless otherwise specified, relate to the weight percentage of the specified or active ingredient based on the dry weight of the binder, or the dry weight of the composition, as appropriate. In other words, the weight percentages of the binder or the composition are based on the state of the binder or composition after the amount of water in the binder or composition has stabilised and/or equilibrated with the ambient or surrounding atmosphere, and/or when water has been driven off by the desired degree of forced drying. In embodiments, some components of the claimed composition may be provided as a solution in a solvent, typically water, for example, sodium silicate is typically provided as a 40 w/w solution in water, sometimes called silica glass. In some instances, the amount of silicate, or other components such as reactants or accelerators, when present, may be described by the weight of this aqueous solution rather than the dry weight of the active ingredient, however, this should be distinguished over the weight percentages of the dry weight of the binder or composition as provided herein.

As used herein, the term ‘biodegradable’ means capable of being broken down in nature and/or by the action of living things. The term is used herein to refer to compositions, or components of compositions, that naturally break down to innocuous constituents in water or in aqueous or wet environments, typically through dissolving or through the action of naturally occurring microorganisms such as bacteria or fungi.

As used herein the term ‘shiv’ or ‘shive’ means the fibrous woody part of a plant, typically from the talk or stem part. Shiv is generally renewable, recyclable and easily available from sustainable resources. Examples are hemp shiv and flax shiv derived from the hemp plant and flax plant respectively. Other types of shiv may be derived from miscanthus, pine, maize, sunflower, bamboo and other plants.

As used herein, the term ‘binder’ or ‘binder material’ means a material or substance that holds or draws the bio-aggregate, or other solid component of the composition together by adhesion or cohesion, to form a cohesive whole, mechanically or chemically. In embodiment of the present invention, the term ‘binder’ is intended to refer to the substance, or mixture of substances that holds, or draw the bio-aggregate together by adhesion. Essentially, the ‘binder’ is the material interspersed between the bio-aggregate or other solid or support of the composition. While in embodiments, the binder is the only component in the composition with the bio-aggregate or other solid or support, in other embodiments, the composition may further comprise additives that mix with the binder, or otherwise form part of the composition.

As used herein, the term ‘silicate’ refers to any member of a family of anions consisting of silicon and oxygen, usually with the general formula [SiO₄₋ₓ^{(4-2x)-}]ₙ, where 0≥x<2. The family includes orthosilicate SiO₄⁴⁻ (x=0), metasilicate SiO₃²⁻ (x=1), and pyrosilicate Si₂O₇⁶⁻ (x=0.5, n=2). The name is also used for any salt of such anions, such as sodium metasilicate; or any ester containing the corresponding chemical group, such as tetramethyl orthosilicate. Silicate anions are often large polymeric molecules with a variety of structures, including chains and rings (as in polymeric metasilicate [SiO₃²⁻]ₙ), double chains (as in [Si₂O₅²⁻]ₙ, and sheets (as in [Si₂O₅²⁻]ₙ. Silicates may form salts with any suitable cation, most commonly metals selected from Group 1 or Group 2 of the periodic table such as potassium, sodium and magnesium. The term ‘silicate’ does not extend to ‘aluminosilicates’ or ‘hydrated aluminosilicates’ (sometimes referred to as zeolites) that are generally mineral materials composed of aluminium, silicon and oxygen plus counterions which are a major component of kaolin and other clay materials.

As used herein, the term ‘sodium silicate’ means a sodium salt of a silicate anion. Sodium silicates have the IUPAC chemical structure of Na₂ₓSi_{y}O_{2y+x} or (Na₂O)ₓ·(SiO₂)_{y}. with examples being sodium metasilicate (Na₂SiO₃), sodium orthosilicate (Na₄SiO₄), and sodium pyrosilicate (Na₆Si₂O₇), or mixtures thereof, the mixtures often having a higher proportion of the metasilicate. As specified herein sodium silicate can be provided as a solid or as a solution in water or other suitable solvent, often referred to as liquid sodium silicate or water glass.

As used herein, the term ‘carbonate’ refers to any member of a family of anions consisting of carbon and oxygen, usually with the general formula [CO₃²⁻]. The term ‘carbonate’ may alternatively refer to any compound formed by the reaction of a silicate and carbon dioxide. Carbonates may form salts with any suitable anion, most commonly metals selected from Group 1 or Group 2 of the periodic table such as potassium, sodium and magnesium. Specifically, the term ‘sodium carbonate’ refers to any product formed from the reaction of sodium silicate and carbon dioxide. Sodium carbonate typically has the structure Na₂CO₃. A potential stoichiometry of the reaction is 2NaOH·SiO₂+CO₂→Na₂CO₃+2SiO₂+H₂O. Sodium silicate has a molecular weight of 140 and can potentially be converted into carbonate with a molecular weight of 106, so 100% conversion would be 75.7% by weight of binder.

As used herein, the term ‘aggregate’ means coarse- to medium-grained particulate material used to make concrete and in construction, including sand, gravel, crushed stone, slag, recycled concrete and geosynthetic aggregates. As used herein, the term “bio-aggregate” refers to plant-derived substitution materials for aggregates, such as plant-based shiv, for example hemp shiv. Bio-aggregates suitable for use in concrete substitutes may be larger than the bio-aggregates used for replacement of finer cement-based materials such as mortars or plaster. Larger bio-aggregates may be in the region of 15-25 mm particles, with smaller bio-aggregates may be in the region of 2-5 mm particle sizes. The measurement of particle sizes for shiv and other bio-aggregates is often complicated by the fact that the particles vary in size and shape and are often elongated. One suitable method for measurement of particle size of bio-aggregates is by the average particle size by weight, measured by a sieving method. Such a method is described, for example, in section 4.5.2.3 of “Recommendation of the RILEM TC 236-BBM: characterisation testing of hemp shiv to determine the initial water content, water absorption, dry density, particle size distribution and thermal conductivity; Amziane et al., Materials and Structures (2017); 50:167 (https://hal-univ-rennes1.archives-ouvertes.fr/hal-01523118/document; accessed 3 Aug. 2020). A sample of the bio-aggregate is tested in a sieving apparatus in accordance with EN 932-5, comprising sieves with incrementally-decreasing apertures (the apertures being in accordance with EN 933-2). From the increase in weight of each sieve the distribution of particle sizes allows for a weight average size to be obtained. Alternatively, from the same data, the particle size can be given as a set cumulative amount passing a given size, for example, 90% of the particles are less than 25 mm is size, although any cumulative percentage, or combination of cumulative percentages that provides details of the particle size distribution of the bio-aggregate is appropriate. Such sieve data may be supplemented by image analysis data to further define the particle size and shape of the bio-aggregate. The composition of the present invention may comprise bio-aggregate alone, or a mixture of bio-aggregate with aggregate and other solid support for the binder such as render mesh or paper.

As used herein, the term ‘support’ means a solid physical material that the binder adheres to or holds or draws together by cohesion or adhesion. This term could encompass an aggregate or bio-aggregate, but may also include other solid support materials that form part of (i.e. are integral to and/or are on the surface of) the final composition, such as fibres, rods, mesh or paper.

As used herein, the term ‘breathable’ or ‘breathability’ means the ability of a fabric or material to allow moisture or water vapour to be transmitted therethrough. This is in contrast to ‘air permeability’ which is the ability of a fabric or material to allow air to pass through. Air permeability in insulation for example may be detrimental to heat retention, whereas a breathable insulation may retain heat while allowing passage of water vapour. Breathability may be measured by any known standard vapour permeability or vapour resistance method. The vapour resistance of a material is a measure of the material's reluctance to let water pass through. Vapour resistance is dependent on the material's thickness and so any value for vapour resistance must be quoted for a particular thickness, or normalised to a given unit thickness. The unit of vapour resistance is commonly mega-Newton seconds per gram, or MNs/g, One commonly used measure of vapour resistance of a material is the μ-value, this is the water vapour resistance factor. The p-value of a material is the ratio between the water vapour permeability of air at 23° C. and 1 bar, and the water vapour permeability of the material. As the μ-value is a relative quantity it is expressed as a number with no units and is used as a multiplier to the materials final thickness

As used herein, the term ‘U-value’ means the sum of the thermal resistances of the layers that make up an entire building element—for example, a roof, wall or floor. It also includes adjustments for any fixings or air gaps. A U-value value shows, in units of W/m²K, the ability of an element to transmit heat from a warm space to a cold space in a building, and vice versa. The lower the U-value, the better insulated the building element.

As used herein, the term ‘carbon footprint’ means the carbon footprint of a product, for example the binder, and is the full inventory of all greenhouse gas emissions released throughout the production of a product or service, from the extraction of its raw materials to leaving the production facility (sometimes referred to as ‘cradle-to-gate’). It is expressed in carbon dioxide equivalents (CO₂e). The products may be certified to internationally recognised standards for carbon footprint such as the GHG Protocol Standard, ISO 14067 and PAS 2050.

As used herein, the term ‘carbon dioxide equivalent’ or ‘CO₂e’ is a standard unit for measuring carbon footprints. This allows the expression of the impact of each different greenhouse gas in terms of the amount of CO₂ that would create the same amount of global warming. In this way, a carbon footprint consisting of lots of different greenhouse gases can be expressed as a single number. Standard ratios are used to convert the various gases into equivalent amounts of CO₂. These ratios are based on the so-called global warming potential (GWP) of each gas, which describes its total warming impact relative to CO₂ over a set period—typically one hundred years. Over this time frame, according to the standard data (for example, “Forster, P., et al, 2007: Changes in Atmospheric Constituents and in Radiative Forcing. In: Climate Change 2007: The Physical Science Basis. Contribution of Working Group I to the Fourth Assessment Report of the Intergovernmental Panel on Climate Change [Solomon, S., D. Qin, M. Manning, Z. Chen, M. Marquis, K. B. Averyt, M. Tignor and H. L. Miller (eds.)]. Cambridge University Press, Cambridge, 2007), methane scores 25 (meaning that one tonne of methane will cause the same amount of warming as 25 tonnes of CO₂), nitrous oxide is 298 and some fluorinated-gases score more than 10,000.

As used herein, the term ‘reactant’ or ‘hardener’ refers to a chemical or combination of chemicals that can chemically react with a silicate to alter its composition and/or chemical or material properties. Without wishing to be bound by theory, it is considered that the reaction is generally an acid-base/alkali reaction between the alkaline silicate and these materials. Some reactants are acidic, such as carbonic acid formed when CO₂ dissolves in water or are acid-forming esters such as ethyl acetate and glycerol triacetate. Glycerol triacetate is the most rapidly reacting, and the most benign in terms of its safety profile. An example of a reactant for silicates is carbon dioxide (or more precisely carbonic acid, carbon dioxide dissolved in water). Calcium Chloride, Magnesium Chloride, Magnesium Carbonate, Magnesium Sulfate, Aluminium Sulfate, Formamide (2%-10%), Sodium Bicarbonate, Sodium Aluminate, Glyoxal, Ethyl Acetate, Glycerol Triacetate (Triacetin) may be used as an alternative to or in addition to carbon dioxide (CO₂) as a reactant.

As used herein the term ‘oxidising agent’ refers to an accelerant that reduces the setting time of the silicate bio-composite of the present invention. The term ‘oxidising agent’, ‘oxidant’ and ‘accelerant’ when used in this context are intended to be synonymous. Suitably, the accelerant or oxidising agent for use in the present invention is hydrogen peroxide.

As used herein the term ‘surfactant’ is intended to take its common meaning in the art as a substance that lowers the surface tension between two liquids, for example a hydrophilic liquid and a hydrophobic liquid. Surfactants find general use as foaming agents. The term “surfactant” and “foaming agent” as used herein are intended to be synonymous. Suitably, the surfactant for use in the present invention is any surfactant compatible with alkaline environments, such as alkyl sulfonate or commercially available surfactants such as Sika® AER5.

### DETAILED DESCRIPTION

This invention generally relates to a biodegradable composition comprising a binder and bio-based aggregate material, or the binder thereof. In embodiments, the invention relates to the use of a silicate, for example, sodium silicate as a binder, suitably for use as a binder for bio-based aggregates, such as hemp shiv. In embodiments, the invention relates to a sustainable composition comprising a silicate, such as sodium silicate and optionally a bio-based aggregate such as hemp shiv or other aggregate or support, as a pre-cast insulation material, as a bonded sheet material, or otherwise in construction.

Concrete, a composite of cement and aggregate, remains widely used in the construction industry despite the environmental concerns relating to its production. While recently, alternatives, in particular hemp-lime, have offered some advantages over concrete, particularly in avoiding the use of cement which is responsible for much for the carbon footprint of concrete, these alternatives still suffer from certain disadvantages,

Firstly, in order to achieve acceptably low thermal conductivity, the amount of binder used in hemp-lime is insufficient to create a material that is sufficiently robust to be machined or even handled roughly.

Secondly, traditional hemp-lime, requires a large amount of excess water in the initial mixing and casting stage, and if allowed to dry naturally, this can take up to two years to stabilise. While forced air drying techniques may be employed, this increases the carbon footprint and the time required for production.

The present invention overcomes at least these disadvantages by providing a novel alternative biodegradable binder, optionally a binder for bio-aggregates based on silicates, in particular, sodium or potassium silicate, or combinations thereof.

The binder of the present invention generally comprises a silicate, wherein the silicate is present in the binder in an amount greater than 50% based on the weight of the binder. In embodiments, the silicate may be present in the binder in as much as 55 wt %, 60 wt %, 65 wt %, 70 wt %, 75 wt %, 80 wt %, 85 wt %, 90 wt %, 95 wt %, 98 wt %, 99 wt % or more, based on the total weight of the binder. The binder may further comprise water. In embodiments, the silicate binder is sodium silicate.

In embodiments, the binder comprises a reactant. In embodiments, the reactant may be present in the binder is an amount of at least 0.5 wt %, 1.0 wt %, 1.5 wt %, 2.0 wt %, 2.5 wt %, 3.0 wt %, 4.0 wt %, 5 wt %, 7 wt %, 10 wt %, 12 wt %, 15 wt %, 17 wt % or 20 wt % or more with respect to the total weight of the binder. In embodiments, the reactant may be present in the binder is an amount of at most 20 wt %, 17 wt %, 15 wt %, 12 wt %, 10 wt %, 7 wt %, 5 wt %, 4 wt %, 3.5 wt %, 3.0 wt %, 2.5 wt %, 2.0 wt %, 1.5 wt % 1.0 wt % or 0.5 wt % or less with respect to the total weight of the binder. Suitably, the reactant is present in an amount between 3 to 15 wt % of the binder with respect to the total weight of the binder, suitably the reactant is present in an amount between 5 wt % to 12 wt % of the binder with respect to the total weight of the binder.

The molar ratio of the silicate to the anion, for example, sodium or potassium can vary from 1:1 to 1:3.4 (SiO₂: NaO₂/K₂O). Suitably, the silicate is provided as an aqueous solution of silicate with a weight ratio of silicate to water of 1:3 or greater, for example 40 wt % sodium silicate in water.

In embodiments, the reactant is selected from the group consisting of: carbonic acid (CO₂ dissolved in water), calcium chloride, magnesium chloride, magnesium carbonate, magnesium sulfate, aluminium sulfate, formamide (2%-10%), sodium bicarbonate, sodium aluminate, glyoxal, ethyl acetate, glycerol triacetate (Triacetin) and combinations thereof. Suitably the reactant is ethyl acetate or glycerol triacetate. More suitably the reactant is glycerol triacetate. glycerol triacetate may be chosen over, for example ethyl acetate, for its superior health and safety profile.

In embodiments, the composition may comprise an oxidising agent and optionally a surfactant. The oxidising agent has dual functions of foaming the binder; and reducing the set time. Addition of an oxidising agent is not essential but can be advantageous in certain applications of the invention. In small amounts, for example approximately 0.1 wt % to approximately 5 wt %, the oxidising agent can reduce setting times of the composition from hours to minutes, or even less than 1 minute. The rate of set can be varied through the amount of oxidising agent added with 5 wt % oxidising agent allowing the composition to set within 30 seconds, equally, the foamed binder generally has a lower density and thermal conductivity than non-foamed compositions. Foamed binders, or compositions comprising the foamed binder and a bio-aggregate in accordance with an embodiment of the present invention may therefore can be used to create a lightweight, insulating, non-combustible material, especially board materials.

In embodiments, the oxidising agent is hydrogen peroxide (H₂O₂) which, as well as being an effective oxidising agent, liberates oxygen gas and water on reaction/decomposition which can lead to some foaming. In some embodiments, the oxidising agent may be considered a foaming agent. The liberation of oxygen in the presence of an alkaline solution is understood to cause the foaming. It is possible that it is the presence of oxygen that either catalyses the setting of the composition or the oxygen combines chemically to produce a more rapid set.

Suitably when an oxidising agent is present it comprises between 0.5 to 15% by weight of the binder, based on the total weight of the binder.

In embodiments, the binder comprises at least 0.5 wt %, 0.6 wt %, 0.7 wt %, 0.8 wt %, 0.9 wt %, 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt % 10.5 wt %, 11.0 wt %, 11.5 wt %, 12.0 wt % 12.5 wt %, 13.0 wt %, 13.5 wt %, 14.0 wt %, or 14.5 wt oxidising agent. In embodiments, the binder comprises at most 15 wt %, 14.5 wt %, 14.0 wt %, 13.5 wt %, 13.0 wt %, 12.5 wt %, 12.0 wt %, 11.5 wt %, 11.0 wt %, 10.5 wt %, 10.0 wt %, 9.5 wt %, 9.0 wt %, 8.5 wt %, 8.0 wt %, 7.5 wt %, 7.0 wt %, 6.5 wt %, 6.0 wt %, 5.5 wt %, 5.0 wt %, 4.5 wt %, 4.0 wt %, 3.5 wt %, 3.0 wt %, 2.5 wt %, 2.0 wt %, 1.5 wt %, 1.0 wt %, 0.9 wt %, 0.8 wt %, 0.7 wt %, or 0.6 wt % oxidising agent. All weights based on the total weight of the binder.

In embodiments, the surfactant, when present, is any surfactant that is compatible with alkaline environments, for example alkyl sulfonate or commercially available surfactants such as Sika® AER5.

Suitably, the binder comprises between 1 to 10% by weight surfactant, based on the total weight of the binder, suitably 4% by weight surfactant, based on the total weight of the binder. In embodiments, the binder comprises at least 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, or 9.5 wt % surfactant. In embodiments, the binder comprises at most 10.0 wt %, 9.5 wt %, 9.0 wt %, 8.5 wt %, 8.0 wt %, 7.5 wt %, 7.0 wt %, 6.5 wt %, 6.0 wt %, 5.5 wt %, 5.0 wt %, 4.5 wt %, 4.0 wt %, 3.5 wt %, 3.0 wt %, 2.5 wt %, 2.0 wt %, 1.5 wt %, or 1.0 wt % surfactant. All weights based on the total weight of the binder.

In embodiments, the binder comprises only a silicate, such as sodium silicate, with any remainder of the composition being water. In other words, and as defined herein, the composition may consist of a silicate, or may consist of a silicate and water. In other words, the weight percentages of these components may add up to 100% by weight based on the total weight of the binder.

In embodiments of the present invention, there is provided a composition comprising the silicate as hereinbefore described and a bio-aggregate, the bio-aggregate material may be any suitable material derived from plants, or other suitable biodegradable material. Suitably, the bio-aggregate material may be flax shiv, chopped sunflower stalk, chopped cereal straw, cork particles, corn cob particles, wood chip. More suitably, the bio-aggregate material is hemp shiv.

In embodiments, the composition comprises only a silicate binder, such as sodium silicate, and a bio-aggregate material, such as hemp shiv, with any remainder of the composition being water. In other words, and as defined herein, the composition may consist of a silicate binder and a bio-aggregate material, or may consist of a silicate binder and a bio-aggregate material and water. In other words, the weight percentages of these components may add up to 100% by weight based on the total weight of the composition.

In embodiments where the composition is exposed to carbon dioxide during drying then some of the silicate, suitable sodium silicate, may be converted to a carbonate, such as sodium carbonate. In this context, carbon dioxide is used as a reactant as defined herein. For gaseous reactants, such as carbon dioxide, introduced via forced gas perfusion, the degree of conversion and the amount of converted material, such as carbonate, in the final composition is difficult to predict, and so the invention is intended to encompass small amounts, for example up to 1% by weight of the binder, up to 2% by weight of the binder, up to 5% by weight of the binder, up to 10% by weight, up to 15% by weight or up to 20% by weight of the binder in the final composition being material converted by reaction of the silicate and the reactant, such as carbonate, such as sodium carbonate, derived from the starting silicate binder by reaction with carbon dioxide or other reactant or carbonating agent.

In alternative embodiments, a reactant may be provided in the binder mixture. The reactant may be chosen from any suitable material that can react with the silicate in the binder and promote the desired chemical change that results in the desired chemical and physical properties. The reactant may be chosen on the basis of its desired properties, hazard profile, and cost, or a combination thereof. The amount of reactant may be selected to achieve the desired result. Typically, the reactant, when present, is evenly or homogeneously mixed with the silicate in the binder.

Without wishing to be bound by theory, it is understood that the reactant in the binder reacts with the silicate to a degree in order to change the chemical composition of the binder locally or generally to achieve the desired chemical or physical properties of the set material as a whole. The reactant, and the amount of reactant added to the binder, along with other components and conditions for mixing and setting may be selected to achieve pre-determined properties.

In embodiments that comprise a reactant, the binder may comprise only a silicate, such as sodium silicate, the reactant and/or the product of the silicate and the reactant, such as a carbonate, suitably sodium carbonate, or the product of the reaction between a silicate and ethyl acetate or glycerol triacetate with any remainder of the composition being water. In other words, and as defined herein, the binder may consist of a silicate, the reactant and/or the product of the silicate and the reactant; or a silicate binder, the reactant and/or the product of the silicate and the reactant, and water. In other words, the weight percentages of these components may add up to 100% by weight based on the total weight of the binder.

In embodiments that comprise a reactant, the composition may comprise only a silicate binder, such as sodium silicate, the reactant and/or the product of the silicate and the reactant, such as a carbonate, suitably sodium carbonate, or the product of the reaction between a silicate and ethyl acetate or glycerol triacetate, and a bio-aggregate material, such as hemp shiv, with any remainder of the composition being water. In other words, and as defined herein, the composition may consist of a silicate binder, the reactant and/or the product of the silicate and the reactant, and a bio-aggregate material; or a silicate binder, the reactant and/or the product of the silicate and the reactant, and a bio-aggregate material and water. In other words, the weight percentages of these components may add up to 100% by weight based on the total weight of the composition.

In embodiments of the binder and composition as hereinbefore described, it is contemplated that other minor additives may be included that may provide one or more benefits without affecting the overall properties of the binder or composition. In other words, and as defined herein, the composition may consist essentially of a silicate binder (with or without a reactant and/or products of the silicate and the reactant), such as sodium silicate, and optionally a bio-aggregate material, such as hemp shiv, or a silicate binder (with or without a reactant and/or products of the silicate and the reactant), such as sodium silicate, and optionally a bio-aggregate material, such as hemp shiv, and water.

The term ‘minor additives’ is intended to relate to additives other than a silicate binder, a reactant and/or products of the silicate and the reactant, and optionally a bio-aggregate material, that may be present in the composition in an amount of 20 wt % or less. Suitably, less than 15 wt %, 10 wt %, 5 wt %, 2 wt %, 1 wt % or less. All weight percentages based on the total weight of the composition. In other words, the weight percentages of the silicate binder, such as sodium silicate (with or without a reactant and/or products of the silicate and the reactant), optionally the bio-aggregate material, water and the minor additive(s) may add up to 100% by weight based on the total weight of the composition.

The minor additives may be, although not limited to: inorganic materials such as zinc oxide and/or amorphous calcium carbonate to confer water resistance; bio-based mesh to reinforce the structure.

Zinc oxide and/or amorphous calcium carbonate may be added to the composition as an additive in order to decrease the water solubility of the composition. Without wishing to be bound by theory, a composition that is less water soluble would be less prone to excessive moisture ingress, or may better shed water, such as rainwater, and therefore may render the composition more suitable for use ground-side of damp-proof courses and in areas that are exposed to the external environment or moisture.

Zinc oxide may also be used as a chemical setting agent which following curing at elevated temperature after drying may provide the composition with a hydrophobic surface film which would again be expected to improve the compositions resistance to moisture, and thereby its performance and longevity in external or damp conditions.

In embodiments, the composition provides the binder in a solution that can confer water resistance or other desirable properties. For example, in embodiments, the binder may be added in an aqueous latex dispersion. The aqueous latex dispersion may be in any suitable proportion.

For example, aqueous latex dispersion may comprise 50 vol % latex and 50 vol % water. The binder may be present in the dispersion in an amount of from 0.2% to 30% by weight of binder, suitably 0.2% to 10% based on the total weight of the dispersion.

In embodiments of the composition in accordance with the present invention, the composition may comprise the binder in an amount of from 5% to 95% by weight, and bio-aggregate in an amount of from 95% to 5% by weight, water in an amount of from 0% to 10% by weight. In embodiments, and optionally, the composition may further comprise from 0.1% to 10% by weight additive. All weight percentages are based on the total weight of the composition and must total no more than 100%. The weight percentage of the binder includes any silicate material that has been converted to another product by reacting with a reactant on drying/curing.

In a specific embodiment of the composition in accordance with the present invention, the composition may comprise a silicate, suitably sodium or potassium silicate (dry weight) in an amount of from 10% to 60% by weight, bio-aggregate in an amount of from 90% to 40% by weight, water in an amount of from 0% to 10% by weight. In embodiments the composition may further comprise from 0.1% to 15% by weight additive, suitably from 0.1% to 15% by weight additive. All weight percentages are based on the total weight of the composition and must total no more than 100%.

In embodiments, the composition comprises at least 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, or 85 wt % binder. In embodiments, the composition comprises at most 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, or 15 wt % binder. All weights based on the total weight of the composition.

In embodiments, the composition comprises at least 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, or 85 wt % bio-aggregate, suitably hemp shiv. In embodiments, the composition comprises at most 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, or 15 wt % bio-aggregate, suitably hemp shiv. All weights based on the total weight of the composition.

In embodiments, the composition, when dry and/or, immediately after drying comprises between 0.01 and 1 wt %, at least 1 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 10 wt %, 15 wt % or 20 wt % water, as measured by heating the composition to dry weight. In embodiments, the composition immediately after drying comprises at most 20 wt %, 15 wt %, 10 wt %, 9.0 wt %, 8.5 wt %, 8.0 wt %, 7.5 wt %, 7.0 wt %, 6.5 wt %, 6.0 wt %, 5.5 wt %, 5.0 wt %, 4.5 wt %, 4.0 wt %, 3.5 wt %, 3.0 wt %, 2.5 wt %, 2.0 wt %, 1.5 wt %, 1.0 wt %, or between 1.0 to 0.01 wt % water, as measured by heating the composition to dry weight. All weights based on the total weight of the composition.

The binder or composition is generally hygroscopic and therefore, depending on environmental conditions, may absorb water on standing. The moisture content (MC) or equilibrium water content (EMC) may be greater than the amounts above. For example, an EMC of the binder or composition is likely to be between 5 wt % and 10 wt %, based on the weight of the binder or composition respectively. When saturated, the MC of the binder or composition may be anywhere up to 20 wt %, 30 wt %, 40 wt %, 50 wt %, 60 wt %, 70 wt %, 80 wt %, 90 wt %, 100 wt %, 150 wt %, 200 wt %, 250 wt %, 300 wt %, 350 wt %, 400 wt %, or 450 wt % or more, based on the weight of the dried binder or composition.

In embodiments, the binder or composition comprises at least 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt % 10.5 wt %, 11.0 wt %, 11.5 wt %, 12.0 wt % 12.5 wt %, 13.0 wt %, 13.5 wt %, 14.0 wt %, 14.5 wt %, 15 wt %, 17.5 wt % or 20 wt % additives. In embodiments, the composition comprises at most 20 wt %, 17.5 wt %, 15 wt %, 14.5 wt %, 14.0 wt %, 13.5 wt %, 13.0 wt %, 12.5 wt %, 12.0 wt %, 11.5 wt %, 11.0 wt %, 10.5 wt %, 10.0 wt %, 9.5 wt %, 9.0 wt %, 8.5 wt %, 8.0 wt %, 7.5 wt %, 7.0 wt %, 6.5 wt %, 6.0 wt %, 5.5 wt %, 5.0 wt %, 4.5 wt %, 4.0 wt %, 3.5 wt %, 3.0 wt %, 2.5 wt %, 2.0 wt %, 1.5 wt %, 1.0 wt %, 0.9 wt %, 0.8 wt %, 0.7 wt %, 0.6 wt %, 0.5 wt %, 0.4 wt %, 0.3 wt %, 0.2 wt %, or 0.1 wt % additives. All weights based on the total weight of the binder or composition respectively.

The composition of the present invention is breathable, i.e. it allows moisture or water vapour to be transmitted therethrough, but offers a high inherent U-value making it particularly suitable for use as insulation. All other suitable uses of the composition remain contemplated.

In embodiments, the composition has a p vapour diffusion resistance similar to that of hemp-lime. In embodiments, the composition has p vapour diffusion resistance of from 2 to 8, more suitably from 3 to 6.

In embodiments, the composition has thermal conductivity lower than that of hemp-lime. In embodiments, the composition has thermal conductivity of from 0.02 to 0.2 W/m⁻¹K⁻¹, more suitably from 0.02 to 0.1 W/m⁻¹K⁻¹. In one embodiment, the composition has a thermal conductivity of 0.074 W/m⁻¹K⁻¹. The thermal conductivity of the composition of the present invention may be from 5 to 20% less than hemp-lime which typically has a thermal conductivity of 0.085 W/m⁻¹K⁻¹.

In embodiments, the composition has compressive strength similar to that of hemp-lime. In embodiments, the composition has compressive strength of from 0.1 to 0.4 MPa, more suitably from 0.2 to 0.25 MPa. In one embodiment, the composition has a compressive strength of 0.2 MPa.

One advantage of the composition of the present invention is the ability to match or increase the density of the material compared to that of other biodegradable binder and bio-aggregate mixes, for example hemp-lime.

In embodiments, the composition has a density of from 100 to 500 kg/m³, suitably from 200 to 400 kg/m³. The density of the material may be increased by any suitable means, for example, mechanical compression. An increase in density would be expected to result in improved compressive strength figures.

While the composition of the present invention, or products formed therefrom, exhibit surprisingly beneficial properties in terms of thermal conductivity and density, the compositions, or products formed therefrom, also exhibit an exceptionally low carbon footprint.

As an example, the carbon footprint of a cubic metre of hemp-lime with a density of 330 kg/m³ is −48.4 kg CO₂e (CO₂ equivalent). In comparison the carbon footprint of a cubic metre the composition of the present invention, taken with an example density of 273 kg/m³, is −274.4 kg CO₂e, an increase of 5.7 times in amount of sequestered carbon dioxide over hemp-lime.

In embodiments, the composition has a negative carbon footprint of from −500 to −200 kg CO₂e per cubic metre, suitably from −400 to −250 kg CO₂e per cubic metre, i.e. the composition results in the sequestration of these amount of CO₂ (or equivalents thereof).

The surprisingly beneficial low carbon footprint of the composition is largely due to the reduced carbon footprint of the silicate binder compared to lime binder. The silicate binder of the present invention has an embodied carbon of 7 kg CO₂e per m³ of the composition, compared with the lime binder which embodies 161 kg CO₂e per m³ of hemp-lime.

In embodiments, the silicate binder of the present invention has a carbon footprint of from 0 to 50 kg CO₂e per cubic metre, suitably from 0 to 20 kg CO₂e per cubic metre of the composition formed therefrom. This effectively means that the composite of the present invention is at worst 12.5% of the carbon footprint of the traditional cement binder—i.e. at least 8 times better; and typically 20 times better (5% of the carbon footprint of the binder in the equivalent hemp-lime material).

Sodium silicate is completely incombustible, so the composition has the potential for an insulating low carbon fire resistant material, such as a cladding material.

In a further aspect, the invention relates to products comprising or formed from the binder or composition described above. In embodiments, the product may be a shaped article. Suitably, the shaped article may be an insulation block or panel, board material, cladding, or other construction material or block or panel.

Suitably, the products of the invention, for example insulation blocks, may have a thickness (minimum distance between two surfaces of the product) of from 10 mm to 500 mm or more. Suitably, the products may have a thickness of 10 mm to 300 mm, suitably 10 mm to 75 mm.

The binder or composition of the present invention, or products formed therefrom, may accept coating or may be cast between suitable covering materials, for example natural woven or non-woven fibre materials such as paper, cloth, hessian or bio-based mesh, such as jute mesh. It is envisaged, although not limited to, that this concept would be most suitable for sheet materials such as insulation panels with a relatively low thickness (for example 10 mm to 25 mm) which would rapidly set/cure by exposure to the carbon dioxide in the air. Such materials may be machined, for example with tongue and groove joints such that they could be fitted to avoid air gaps, and thereby increasing the overall U-Value.

Products formed of the silicate binder or of the composition of the present invention, such as insulation blocks and board or panel materials, may be formed by any suitable means, for example casting of the material directly into moulds. In some embodiments, more favourable material properties may be achieved for these products by applying a compressive force to the material during setting/drying. Suitably, initial compression will be applied and then the block will be rapidly demoulded to allow the next block to be cast. Such compressive force may suitably increase the density of the material. In the case of building blocks, typical compression is at a pressure of between approximately 10 kPa and 100 kPa. Board or panel materials typically require the application of pressure for 1 minute to 12 hours post casting at around 200-400 kPa (depending on formulation).

In a further aspect, this invention relates to a method of preparing a composition, such as the composition as defined above, the method comprising the steps of:
(a) combining a binder comprising a silicate and a bio-aggregate to provide a slurry;
(b) mixing the slurry to provide a mixture;
(c) allowing the mixture to set to provide the composition.
   wherein the binder comprises at least 50% by weight of the silicate, based on the total weight of the binder.

The same general method may be applied to the preparation of a silicate binder by the omission of the bio-aggregate in step (a).

In embodiments, the silicate is selected from the group consisting of: sodium silicate; potassium silicate and combinations thereof. Suitably, the silicate is sodium silicate, more suitably liquid sodium silicate, typically a 35 wt % to 40 wt % aqueous solution of sodium silicate.

In embodiments that comprise a bio-aggregate, the bio-aggregate is selected from the group consisting of: hemp shiv flax shiv; chopped sunflower stalk; chopped cereal straw; cork particles; corn cob particles; wood chip and mixtures thereof. The bio-aggregate in step (a) is suitably hemp shiv.

The amount of silicate binder and bio-aggregate added is suitably determined to provide a robust composition. Suitably, the amounts may be based on the desired amount of these components in the final dried composition as detailed above.

In embodiments, the binder comprises at least 70% by weight of the silicate, based on the total weight of the binder. Suitably, the binder comprises at least 85% by weight of the silicate, based on the total weight of the binder. For the avoidance of doubt, the weight percentages of these embodiments refer to the dry weight of the silicate in the binder only. The weight percentages do not refer to that of the composition as a whole, including the bio-aggregate and/or other additives.

In embodiments, the binder of step (a) further comprises a reactant that chemically reacts with the silicate to accelerate setting of the mixture. Suitably, the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate (Triacetin). Suitably, the reactant is ethyl acetate or glycerol triacetate. Suitably, the reactant is glycerol triacetate. Suitably, the binder comprises between 0.5 to 20% by weight reactant, based on the total weight of the binder.

In embodiments, the binder comprises at least 70% by weight of the silicate and reactant, based on the total weight of the binder. Suitably, the binder comprises at least 85% by weight of the silicate and reactant, based on the total weight of the binder. Suitably, the binder consists essentially of the silicate and the reactant. Suitably, the binder consists of the silicate and the reactant. For the avoidance of doubt, the weight percentages of these embodiments refer to the total dry weight of: the silicate, the reactant, and any product from the reaction of the silicate and the reactant, in the binder only. The weight percentages do not refer to that of the composition as a whole, including the bio-aggregate and/or other additives. It will be appreciated, however, that the reactant may be introduced into the composition or binder by any suitable means, including separately from the silicate, or as a solution in the water. Suitably, the silicate is mixed well with the reactant prior to addition of the bio-aggregate. The mixture is then mixed for a suitable time to achieve a uniform mixture, typically 1-5 minutes. The mixing time may be reduced if setting is accelerated through use of an oxidising agent (see below).

The total amount of water added is the sum of the water present in the silicate (if any), for example if 40 v/v aqueous sodium silicate is used, and any additional water added. The total amount of water can be varied to balance the need for sufficient mobility of the combined silicate-bio-aggregate slurry for efficient mixing and the need to remove any extraneous water during drying. In embodiments, the total amount of water added is from 1:3 to 3:1 ratio, suitably 1:2 to 2:1 ratio compared to the total solids weight (based on the dry weight of silicate and bio-aggregate).

In embodiments where a reactant has been included in the binder or composition, setting would be expected within 4-8 hours without any forced drying. The setting time, or the time to stabilise the composition, may be accelerated by the addition of an oxidising agent, such as hydrogen peroxide, suitably in an amount of 1-4 wt %, based on the total weight of the binder, this may mean setting is complete in as little as 1-30 minutes.

The set mixture would have a typical moisture content of around 30 wt % based on the total weight of the binder or composition (dependent whether a bio-aggregate is present). In embodiments, the binder or composition is dried, i.e. the water content is reduced. This allows the binder or composition to be stabilised more quickly. Suitably, the water content is reduced until there is less than 10% weight of water remaining, with respect to the total weight of the binder or composition. Suitably, the binder or composition is dried until there is less than 9% by weight, 8% by weight, 7% by weight, 6% by weight, 5% by weight, 4% by weight, 3% by weight, 2% by weight, or 1% by weight or less of water remaining, with respect to the total weight of the binder or composition as appropriate as measured by heating to dry weight.

In embodiments, the binder is added to the water and mixed to provide a homogeneous solution before adding to the bio-aggregate. Alternatively, the bio-aggregate may be wetted with the water prior to adding the silicate binder, typically liquid sodium silicate. Without wishing to be bound by theory, wetting the bio-aggregate ahead of addition of the silicate binder means that the silicate remains on the external surface of the bio-aggregate to promote interparticle bonding.

In embodiments, after step (b) and before step (c), the composition or binder may be transferred to a mould for curing/drying. The composition or binder may be compressed, by hand or mechanically within the mould, or potentially after demoulding prior to complete drying, to increase the density of the dried material and to expel excess water prior to complete drying. Compression of the binder or composition is suitable for any moulded product and may be particularly appropriate for board or sheet products, either with or without surface coatings such as paper or hessian or other plant fibre mesh, or a polymer render mesh, to increase density and make the products more robust.

In embodiments, drying is conducted at room temperature. Alternatively, or in addition, drying may be accelerated by forcing air or other gases through the mould containing the slurry which effectively drives water from the mixture by evaporation. The drying gases may be pushed and/or sucked through the composition or binder. In addition, or alternatively, drying may be accelerated by using drying gases at elevated temperatures. For example, drying may be conducted with drying gases heated to a temperature from about 80° C. to 300° C., suitably, 100° C. to 200° C., suitably 100° C. to 150° C.

In embodiments, the exhaust gases from the mould may be directed to ambient air or be recycled to the drying gas stream, suitably via a dehumidifier to remove any entrained water. A hood may be placed on the mould to direct exhaust gases appropriately. The forced-air drying may be further accelerated by using heated air or gases.

Injection of carbon dioxide into the mould as a reactant can affect the material properties of the dried composition by varying the degree of carbonation of the silicate that is achieved during drying.

Injection of carbon dioxide, or other suitable carbonation agent, may be achieved by using gases for forced air drying that are rich in, or consist of only, carbon dioxide (or other suitable carbonation agent). Suitably, carbon dioxide is injected into the air being used to dry the composition. This may be done continuously or periodically before and/or during drying. The gas pressure, time of injection, and temperature of the carbon dioxide may be varied dependent on the desired degree of carbonation, which may provide a means for affecting the density of the final composition, for example, a higher pressure of carbon dioxide may be used towards the start of the process where more force is required to force gases through the slurry. Alternatively, or in addition, multiple inlets for the drying gases may be present in the mould to allow greater and more even perfusion of the gases through the drying composition.

The flow of cooling gases, typically air and/or carbon dioxide, can be controlled in terms of both its temperature and flow rate to achieve the desired drying rate, and/or the degree or positioning of carbonation within the composition.

In embodiments, drying is continued until a pre-determined level or until no evidence of dampness remains in the composition, typically seen as darkening at or near the exhaust position(s) of the mould. Visual inspection may determine whether drying is complete, or alternatively for industrial processes, the degree of drying and or carbonation may be ascertained through suitable monitoring equipment and can be manipulated to achieve the desired properties of the material.

It is a particularly advantageous feature of the binder or composition of the present invention that the length of time required to set and/or dry the binder or composition is relatively short. The binder or composition of the present invention is fully set and dry in from 4 to 48 hours, typically, 4 to 36 hours at ambient temperature (approx. 20° C.). The setting time may be further reduced with the addition of a reactant in the binder. The addition of oxidising agents also tends to reduce the setting time. This compares favourably with hemp-lime which even with forced-air drying takes several months to completely stabilise, and standard hemp-lime takes up to two years to fully set.

In embodiments, the carbon dioxide may be forced through the slurry at high pressure before commencing drying which may promote more uniform or complete carbonation. In alternative embodiments, two or more gas inlets may be employed in the mould to provide more uniform distribution of drying air and/or carbon dioxide throughout the slurry.

In embodiments, after step (c), the dried binder or composition is cured at elevated temperature. Suitably, curing may be conducted at a temperature from 80° C. to 300° C., suitably, 100° C. to 200° C., suitably 100° C. to 150° C. This heat-treatment may affect the chemical properties of the material with the aim of increasing robustness, hardness, water resistance, fire resistance, and the ability to machine the material, for example to add jointing fixtures such as tongue and groove edging.

In embodiments, the method may comprise, in step (a), (b) and/or (c), the step of adding one or more additives as defined elsewhere herein. The additives may alternatively be dyes or pigments. These can give colour to the binder or composition.

In a further aspect, this invention relates to a method of producing a product as defined above. In embodiments, the method comprises steps (a)-(b) as defined above for preparing the composition or binder, and, between steps (b) and (c), the step of forming the mixture into a shape for the product prior to drying to enable the production of pre-cast products.

In embodiments, products may be prepared with layers or sections or parts with binders and/or compositions of the present invention that are different from the binder and/or compositions of other layers or sections or parts of the same product.

Similar methods may be applied for the production of products for any number or any order or any combination of layers of different binder and compositions in accordance with the present invention, or any combination of layers of different binder and compositions in accordance with the present invention and layers of different binder and compositions outside the scope of the present invention.

Similar methods may be applied for sectioned or compartmentalised products wherein any form of separation may be used to separate blocks or areas or volumes combination of layers of different binder and compositions in accordance with the present invention and layers of different binder and compositions outside the scope of the present invention within the product. Suitably sections or compartments are created by casting or otherwise setting one material in position before casting or otherwise setting a neighbouring or adjacent material.

In embodiments, the binder or compositions forming a certain layer or compartment or section of the product may be chosen to impart a desired property to the product, for example, a composition may be chosen with a fine bio-aggregate, or a binder with no bio-aggregate may be chosen to provide a smooth outer surface to the product. Equally, a composition of binder may be chosen for a given layer or compartment or section to provide suitable thermal, material, insulation, or sound properties.

In an exemplary embodiment, a layered board product may be formed by the following steps:
a) lining a base of a mould with paper;
b) preparing a silicate binder according to the present invention;
c) pouring this into the mould so that is covers the paper to form a silicate binder layer over the paper;
d) allowing the silicate binder to set;
e) preparing a composition of the present invention comprising a binder comprising a silicate and a bio-aggregate;
f) pouring the composition into the mould so that it covers and silicate binder layer to form a composition layer.

The silicate binder layer without bio-aggregate adjacent the paper allows for a smooth surface of the board product.

In embodiments, the method optionally comprises the following steps:
g) preparing a silicate binder according to the present invention;
h) pouring this into the mould so that is covers the composition layer to form a second silicate binder layer over the composition layer;
i) applying a layer of paper over the second silicate binder layer.

In embodiments, a layered board product formed by the above methods may be compressed to reduce the thickness of the board and increase its density. Such a layered board product may be of use as a plasterboard replacement product.

The forming step may be via any technique which is suitable for mass manufacturing, for example casting, extrusion moulding, compression moulding, press-moulding, injection moulding or rotational moulding. Most suitably, the forming step is casting. The composition of the present invention is suitable for pre-cast mass or bespoke off-site manufacturing, or may be used for in-situ casting on- or off-site.

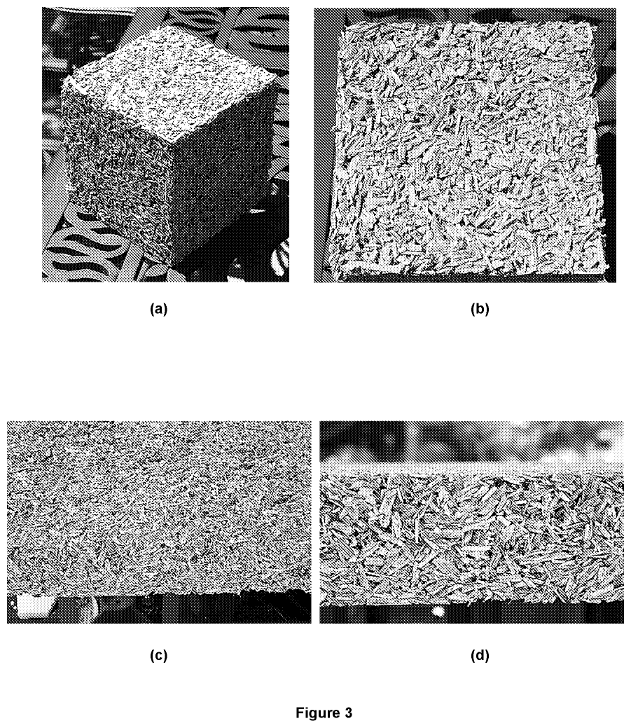

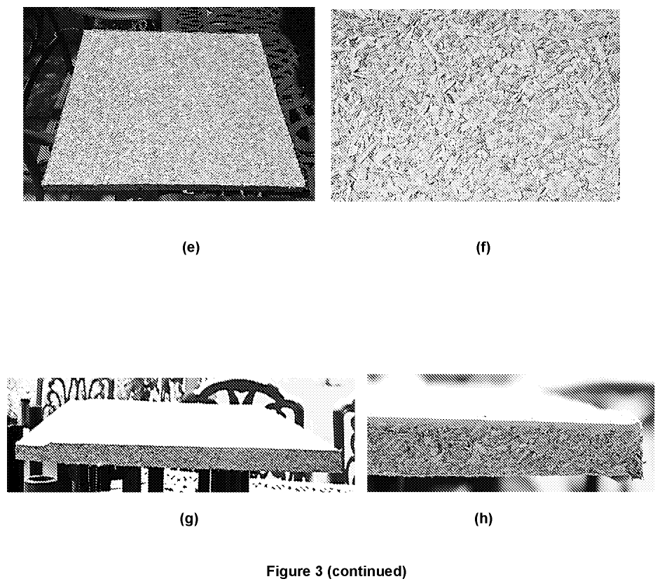

In embodiments, the composition or binder can be cast with an outer covering of paper, and can be shaped to have a tapered edge. In further embodiments, it has been found that addition of an oxidising agent, such as hydrogen peroxide, and optionally a surfactant, provides a foamed binder. Such foamed binders or compositions provide improved surface smoothness which may be advantageous in some application, for example all boards (FIG. 3 (h))

After casting and before or during drying the composition or binder may be compressed, either by hand or mechanically, to increase its density and render it easier to machine. The composition or binder may be cast or moulded between linings such as natural fibres or meshes to improve the mechanical properties. Equally during or after drying a coating may be applied to the composition or binder such as paper sheet for the same purpose.

The breathability, high vapour permeability and exceptionally low thermal conductivity of the composition or binder of the present invention mean it is particularly suitable for use as a material for pre-cast or pre-fabricated insulation blocks or panels. The structural rigidity, further improved through use of a reactant, the addition of additives and/or heat treatments may render the material useful as structural, load-bearing blocks or bricks. All other suitable uses are contemplated.

The performance of the binder or composition of the present invention is improved, or at least comparable to, the current best alternative in terms of biodegradable alternatives to concrete in the form of hemp-lime. Yet with the exceptionally low carbon footprint of the composition of the present invention, it offers an improved environmentally friendly alternative for use in many aspects of construction and elsewhere.

### EXAMPLES

### Example 1—Fabrication of a Hemp Composite with a Sodium Silicate Binder

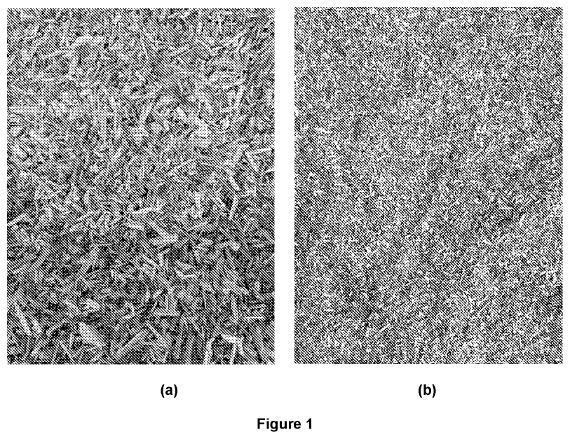

‘HemBuild’ hemp shiv supplied by East Yorkshire Hemp Ltd was used as aggregate. This material had a relatively wide particle size distribution and contained measurable amounts of fibre (FIG. 1). Typical specifications for hemp shiv for use as a bio-aggregate is around 10 mm to 30 mm, suitably 20 mm to 25 mm.

The binder used was liquid sodium silicate 40% supplied by Chemiphase Ltd®.

Casting moulds were manufactured with sides from 12 mm phenolic ply and a base of welded steel mesh made with 3 mm wire with a 22 mm×22 mm open mesh.

Four formulations of compositions in accordance with the present invention were fabricated according to Table 1:

TABLE 1
hemp-silicate formulation

| | Hemp shiv | Liquid sodium | De-ionised water |
|---|---|---|---|
| Formulation # | (gm) | silicate 40% (gm) | (gm) |
| 1 | 500 | 500 | 1000 |
| 2 | 500 | 750 | 750 |
| 3 | 500 | 1000 | 500 |
| 4 | 500 | 250 | 1250 |

The sodium silicate was added to the water and mixed well prior to being added to the shiv. The resulting mixture was then mixed in a planetary mixer [Eibenstock Elektrowerkzeuge] for five minutes.

The wet composite formed was placed into the casting moulds, pressing the material into the edges by hand and the mould filled to the top with moderate hand pressure. The top was struck off using a length of timber.

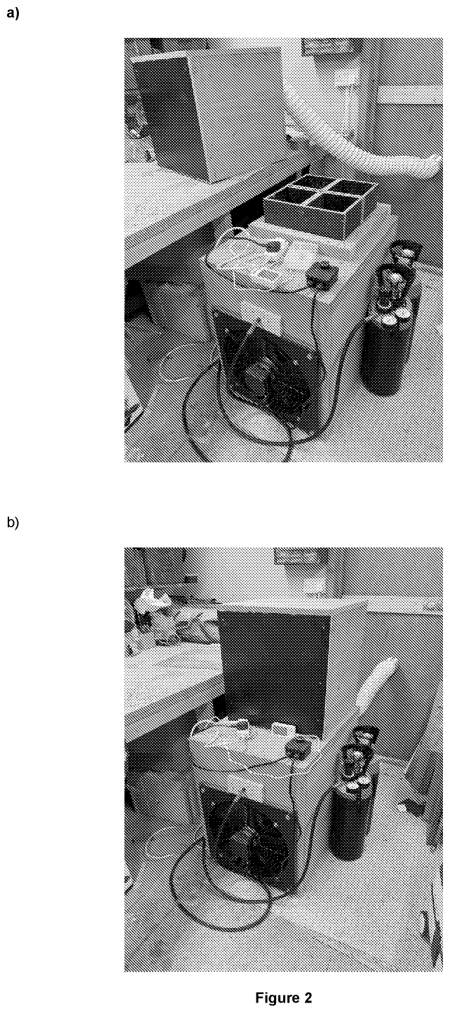

The four moulds were placed into a drying/curing enclosure (FIG. 2)

A hood was placed on top of the specimens in order to direct the drying air to the exterior (FIG. 2(b)).

A fan was used to pressurise the lower chamber of the curing machine with the objective of forcing air through the specimens in order to force-dry them. The rate of flow of air was variable but not measured. Rate of flow was set at the maximum available, although it was noted that there was some ‘blow back’ through the bottom of the fan.

Carbon Dioxide (CO₂) was injected into the lower chamber according to the following sequence (Table 2). CO₂ levels in the laboratory were monitored to ensure safety.

TABLE 2
CO₂ injection timings

| Time from start of process | Gas pressure | Injection duration |
|---|---|---|
| (hrs) | (Bar) | (mins) |
| 0 | 2 | 1 |
| 1 | 0.5 | 3 |
| 2 | 0.5 | 5 |
| 3 | 0.5 | 5 |
| 8 | 0.5 | 5 |

After 24 hours the hood was removed and it was observed that specimens 3 and 4 still showed patches of darker material (dampness) on the top surface. Drying under air pressure continued to a further 12 hours until signs of dampness had disappeared from all specimens.

Specimens were then demoulded, subjected to inspection and weighed (Table 3)

TABLE 3
Results

| Speci- | | Density |
|---|---|---|
| men # | Observations | (kg/m³) |
| 1 | Fairly robust with sharp arris. Adhered to wire mesh, | 178 |
| | but easily removed with damage to lower surface. Top | |
| | and bottom surfaces slightly friable | |
| 2 | Relatively robust with sharp arris. Adhered to wire | 207 |
| | mesh, but possible to be removed with some damage | |
| | to lower surface. Top surface slightly friable | |
| 3 | Robust, sharp arris. Base strongly adhered to wire | 273 |
| | mesh with a clear material. Top surface sound. Bottom | |
| | of the specimen is darker that the middle or top of the | |
| | specimen, which may be due to preferential | |
| | carbonation of the lower part of the specimen. | |
| 4 | Fairly robust with sharp arris. Adhered to wire mesh, | 164 |
| | but easily removed with damage to lower surface. Top | |
| | and bottom surfaces friable | |

It was concluded that all specimens provided good results, and specimen 3 offered a suitable robustness, comparable to hemp-lime yet had a significantly lower carbon footprint, and dried within 36 hours compared to numerous months for hemp-lime.

### Example 2—Fabrication of a Hemp Composite with Sodium Silicate Binder

Four compositions in accordance with the present invention were prepared (Table 4).

Ethyl acetate and glycerol triacetate were used as reactants.

TABLE 4
Hemp-silicate formulations

| | | | Ethyl | Glycerol |
|---|---|---|---|---|
| Formulation | Hemp shiv | Liquid sodium | Acetate | Triacetate |
| # | (gm) | silicate 40% (gm) | (gm) | (gm) |
| 5 (EA50) | 1000 | 1500 | 75 | — |
| 6 (EA75) | 1000 | 1750 | 87.5 | — |
| 7 (GT50) | 1000 | 1500 | — | 75 |
| 8 (GT75) | 1000 | 1750 | — | 87.5 |

The silicate and the chosen reactant were mixed well prior to adding to the shiv. The combined mixture was then mixed in a planetary mixer [Eibenstock Elektrowerkzeuge] for a further 2-5 minutes. Proportions of binder to bio-aggregate (by mass) are as provided in Table 4. Proportions can range from 1:1 to 1:2.5, with the preferred ratio being 1:1.5.

The wet composite formed was placed into the casting moulds, gently pressing the material into the edges by hand to eliminate voids and the mould filled to the top with moderate hand pressure. The top was struck off using a length of timber.

The bio composite set within 8 hours. Moisture content after initial manufacture was of the order of 30%. The moisture content can reduced down to 11% (equilibrium with normal atmospheric conditions) by blowing air through the bio-aggregate for a further 12-24 hours as described in Example 1. This step is optional but allows the material to be stabilised more quickly. Drying can also be done in an oven at 90° C. until mass stabilises (12 hours)

Specimens prepared by the above method (Formulations 5 to 8, Table 4) were subjected to inspection and weighed (Table 5).

TABLE 5
Hemp-silicate formulation density results

| | | Compressed board |
|---|---|---|
| Formulation # | Density (kg/m3) | density (kg/m3) |
| 5 | 200 | — |
| 6 | 210 | 415 |
| 7 | 210 | — |
| 8 | 230 | 420 |

It was concluded that the formulations 5-8 produced good results, comparable to Hemp Lime products which exhibit densities generally between 275-800 kg/m³—around 350 kg/m³ for non-structural use and 600 kg/m³ for pre-cast blocks (Arizzi et al., 2015. PLoS ONE 10(5): e0125520, the content of which is incorporated herein by reference.

The formulations in accordance with the present invention have advantages compared to Hemp Lime, including a much-reduced drying time that is associated with reduced energy requirements and a lower carbon footprint resulting from using a non-cementitious binder. It was found that Formulation 8 would be the most suitable formulation for the production of panels.

### Example 3: Thermal and Mechanical Properties of Hemp-Silicate Formulations

Formulations 5-8 were assessed for their thermal and mechanical properties.

Mechanical Properties

The mechanical properties of the materials were assessed for compressive behaviour according to EN 826:2013. A compressive force is applied at a given rate of displacement perpendicular to the major faces of a squarely cut test specimen and the maximum stress supported by the specimen calculated. When the value of the maximum stress corresponds to a strain of less than 10%, it is designated as compressive strength and the corresponding strain is reported. If no failure is observed before the 10% strain has been reached, the compressive stress at 10% strain is calculated and its value reported as compressive stress at 10% strain.

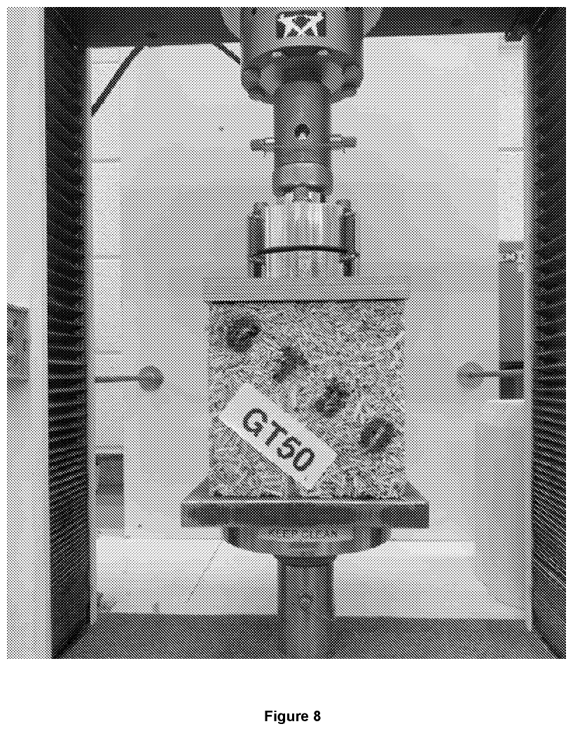

Test specimens were sized to 150 mm×150 mm×150 mm cubes and tested with an Instron 3369 uniaxial testing frame with a 50 kN load cell. A 10 mm/min displacement rate with 22 mm thick plywood platens were used (FIG. 8).

Three specimens for each formulation were tested with the average results and coefficient of variation (in parentheses) provided in Table 6.

Following testing, samples from each specimen was combined to enable the calculation of the moisture content at the time of testing for each formulation (Table 6).

TABLE 6
Compressive properties of hemp-silicate formulations

| | | Maximum | | Strain at | Compressive | Modulus | | |
|---|---|---|---|---|---|---|---|---|
| | | Compressive | | Maximum | stress at | of | | Moisture |
| Formulation | Density | stress | | Compressive | 10% strain | Elasticity | | Content |
| # | (kg/m³) | (MPa) | | stress (%) | (MPa) | (MPa) | | (%) |
| 5 | 197 (2.3) | 0.12 | (9.7) | 5.9 (13.3) | 0.11 (12.9) | 8.23 | (15.8) | 19.3 |
| 6 | 185 (1.7) | 0.10 | (17.4) | 8.7 (29.4) | 0.10 (18.3) | 5.59 | (26.4) | 20.8 |
| 7 | 230 (2.3) | 0.12 | (22.1) | 4.5 (10.2) | 0.11 (18.5) | 8.97 | (29.5) | 17.4 |
| 8 | 251 (2.1) | 0.16 | (13.5) | 4.8 (19.3) | 0.15 (18.7) | 9.95 | (3.5) | 18.1 |

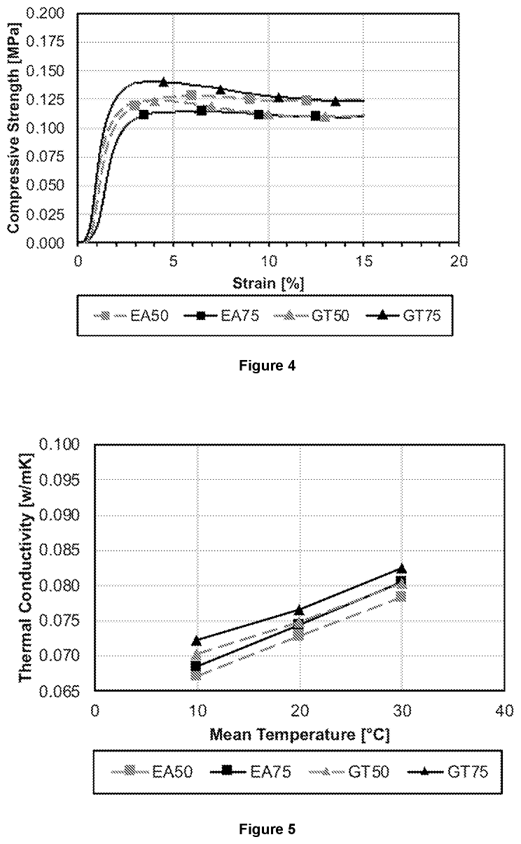

The failure mode for all samples was similar with crushing leading to the samples braking apart into separate hemp shivs (FIG. 4). The samples showed pseudo-plasticity for post peak behaviour.

### Thermal Properties

The thermal properties of the materials were assessed using a Fox Instrument's F600 Heat Flow Meter according to EN 12939:2001. The instrument has an absolute thermal conductivity accuracy of ±1%. The thermal conductivity was measured at three average temperatures 10° C., 20° C. and 30° C. with a 20K vertical gradient across the specimen. The specimens were stored in an environmental chamber at 23° C. and 50% relative humidity and prior to testing were wrapped in plastic film and their mass measured for the calculation of density.

The thermal conductivity of the different formulations was measured with ambient temperature ranging from 19.3° C. to 21.8° C. and ambient humidity ranging from 38.4% to 43.7% (Table 7).

The thickness was measured automatically from the heat flow meter. The change in mass was measured and was insignificant with a maximum mass change of 0.22% for Formulation 8.

TABLE 7
Thermal conductivity results of optimal hemp-silicate formulations

| | | | Thermal | Thermal | Thermal |
|---|---|---|---|---|---|
| | | | Conductivity | Conductivity | Conductivity |
| Formu- | | Thickness | at 10° C. | at 20° C. | at 30° C. |
| lation | Density | tested | mean temp | mean temp | mean temp |
| # | (kg/m³) | (mm) | (Wm⁻¹K⁻¹) | (Wm⁻¹K⁻¹) | (Wm⁻¹K⁻¹) |
| 5 | 173 | 60.48 | 0.0671 | 0.0729 | 0.0784 |
| 6 | 225 | 71.25 | 0.0686 | 0.0745 | 0.0805 |
| 7 | 198 | 57.10 | 0.0703 | 0.0748 | 0.0803 |
| 8 | 236 | 57.47 | 0.0723 | 0.0767 | 0.0826 |

The variation in thermal conductivity with changing temperature is presented in FIG. 5.

The mechanical strength of the formulations was significantly greater than prior art products, such as Hemp Lime, at a similar density, whilst maintaining a similar level of thermal conductivity (see for example Shea et al., 2012. Hygrothermal performance of an experimental hemp-lime building. Table 2, the content of which is incorporated herein by reference; which states that typical thermal conductivity of hemp lime at a density of 220 kg·m⁻³ is 0.06 Wm⁻¹K⁻¹). Additionally, the robustness of the composites and their resistance to abrasion was good.

The ability of the binder to surround the particles of aggregate without being adsorbed was better than expected. This allowed formulations to be created which required no added water, resulting in improved drying times.

The amount of mixing required of the binder and aggregate was found to be minimal. In most cases 1-2 minutes was all that was required to produce a homogenous mixture. This is considerably quicker than the mixing required for Hemp Lime.

### Example 4: Thermal and Mechanical Properties of Hemp-Silicate Panel Products

Board or panel products were prepared by subjecting the formulations 5-8 to 200 kPa to 500 kPa compression for 12 hours after initial casting.

The board products tested in this example did not have any outer covering of paper or other material such as hessian that would be expected to further strengthen the structure. Such products are envisaged and could easily be made by standard techniques using the formulations as described herein, see for example, Example 5.

### Mechanical Properties

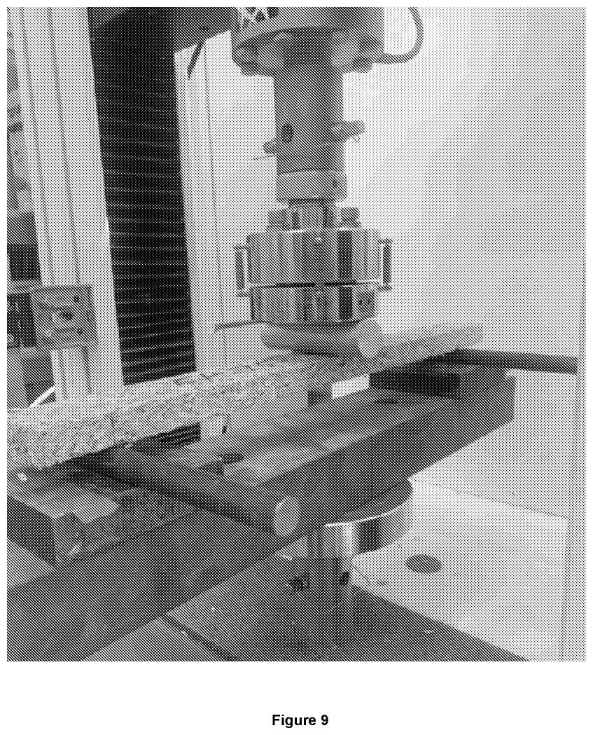

The mechanical properties of the panels were assessed for flexural behaviour according to EN 310:1993. Materials were sized to 50 mm strips and tested with an Instron 3369 uniaxial testing frame with a 50 kN load cell (FIG. 9)

Three specimens for each sample were subjected to bending with the average results and coefficient of variation (provided in brackets) given in Table 8. The modulus of elasticity is calculated between 10% and 40% of the maximum stress in accordance with EN 310. Following the testing of the panels, samples from each specimen were combined to enable the calculation of the moisture content at the time of testing for each panel.

TABLE 8
Compressive properties for panels of hemp-silicate formulations

| Formu- | | | Maximum | Modulus of | Moisture |
|---|---|---|---|---|---|
| lation | Upwards | Density | Flexural Stress | Elasticity | Content |
| # | face* | (kg/m³) | (MPa) | (GPa) | (%) |
| 6 | Top | 379 | 0.629 | 0.210 | 19.8 |
| | | (2.3) | (19.8) | (9.9) | |
| 6 | Bottom | 387 | 0.645 | 0.242 | |
| | | (1.0) | (21.8) | (3.5) | |
| 8 | Top | 401 | 0.535 | 0.222 | 21.2 |
| | | (6.7) | (60.9) | (9.0) | |
| 8 | Bottom | 398 | 0.691 | 0.186 | |
| | | (0.2) | (0.2) | (2.1) | |

*‘Upwards face’ refers to the standard. A notional face is chosen to be ‘upwards’ with the obverse being ‘downwards’ two samples are cut from different parts of the specimen. Variation due to inconsistency of casting

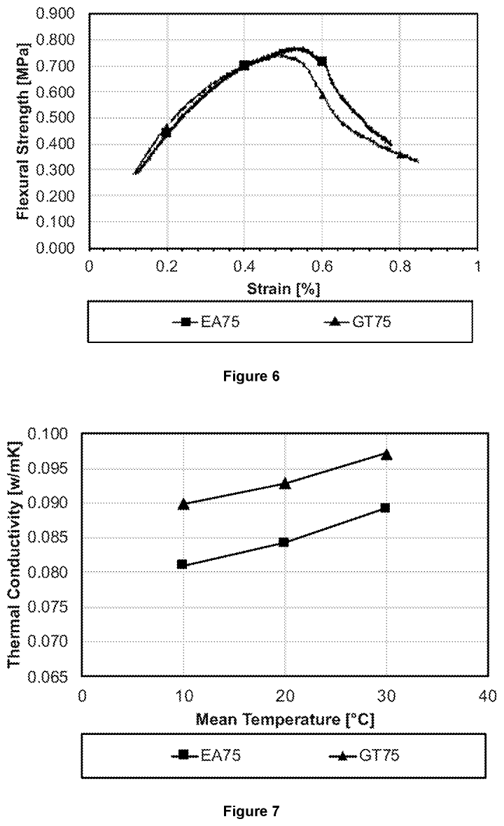

The failure mode for all samples was similar (FIG. 6), with failure occurring on the tension side.

### Thermal Properties

The thermal properties of the materials were assessed using a Fox Instrument's F600 Heat Flow Meter according to EN 12939:2001. The thermal conductivity of the panel samples made from the different formulations was measured with ambient temperature ranging from 21.0° C. to 22.2° C. and ambient humidity ranging from 38.5% to 39.0% (Table 9). The variation in thermal conductivity with changing temperature is presented in FIG. 7. The thickness was measured automatically from the heat flow meter. There was no observed change in thickness and volume. The change in mass was measured and is insignificant with a maximum mass change of 0.34% for Formulation 6.

TABLE 9
Thermal conductivity results for panels
of optimal hemp-silicate formulations

| | | | Thermal | Thermal | Thermal |
|---|---|---|---|---|---|
| | | | Conductivity | Conductivity | Conductivity |
| Formu- | | Thickness | at 10° C. | at 20° C. | at 30° C. |
| lation | Density | tested | mean temp | mean temp | mean temp |
| # | (kg/m³) | (mm) | (W/mK) | (W/mK) | (W/mK) |
| 6 | 365 | 24.06 | 0.0810 | 0.0843 | 0.0892 |
| 8 | 461 | 22.42 | 0.0899 | 0.0929 | 0.0971 |

The thermal conductivity of the panel was considerably lower than Hemp Lime panels of a similar density, which makes the product suitable as an insulation panel.

### Example 5: Formation of Board Products

A board product was fabricated with a core based on the silicate-bio-aggregate core as described herein and lined on a single face with paper.

The mould size used was 350 mm×350 mm and the base of the mould was shaped to form a taper. The base of the mould was lined with 1000 gsm paper wetted with water to allow it to conform to the shape of the mould. A 3 cm overhang was provided at the front and back of the base of the mould.

317 g sodium silicate, 24 g glycerol triacetate and 4 g Sika® AER5 were mixed for 30 secs. 8 g hydrogen peroxide was then added and mixed for a further 10 secs, before Immediately pouring the mixture into the base of the mould and spreading evenly. This mixture set and started to foam within 5 minutes.

Then 480 g hemp shiv with 840 g sodium silicate and 42 g glycerol triacetate were mixed for 1-2 minutes until all the shiv material is evenly coated with the binder. The mixture was the spread onto of the foamed binder previously set in the mould and smoothed into place maintaining an even thickness. The overhanging paper was then folded back over the top of the composite.

400 kPa compressive pressure was applied to the board for 4 hours

The board product was then demoulded and dried either with flowing air or in an oven at 90° C. A ventilated weight can be kept on top of the board to ensure that it does not curl up during drying.

The initial composite thickness around 25-30 mm. The final board thickness was approximately 15 mm

The board product has a smooth external surface and can be used as a dry lining board for the application of plaster or other wall scree or painted with a vapour permeable paint. (FIGS. 3(g) and (h)).

Optionally board products can be cast with an outer covering of paper, and can be shaped to have a tapered edge which may be formed during the casting process.

### Example 6—Fabrication of a Hemp Composite Made with No Reactant

A hemp composite formulation in accordance with the present invention was fabricated according to Table 10.

TABLE 10
Hemp-silicate formulation without reactant

| | | Liquid sodium |
|---|---|---|
| Formulation # | Hemp shiv (gm) | silicate 40% (gm) |
| 9 | 1600 | 2800 |

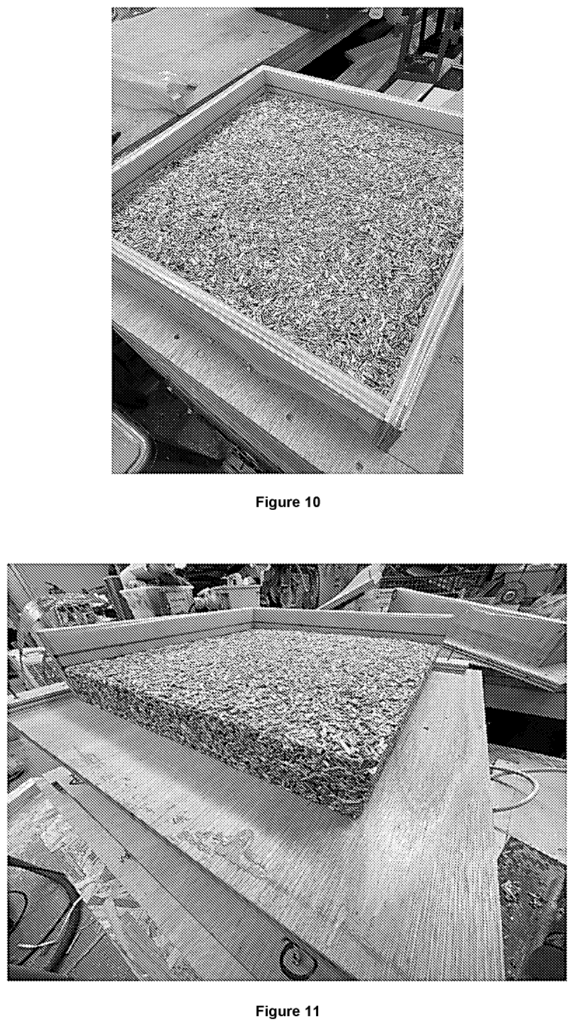

The composition was mixed in a planetary mixer [Eibenstock Elektrowerkzeuge] for 2 to 3 minutes, before the mixed composite was placed in a casting mould and the surface was smoothed with a trowel (FIG. 10).

The mould containing the mixed composition was left open overnight at 16° C. and the mixed composite was allowed to set.

The specimen was demoulded and it was observed that it had a firm set with sharp arises (FIG. 11). Furthermore, the specimen had a slight sheen on its surface.

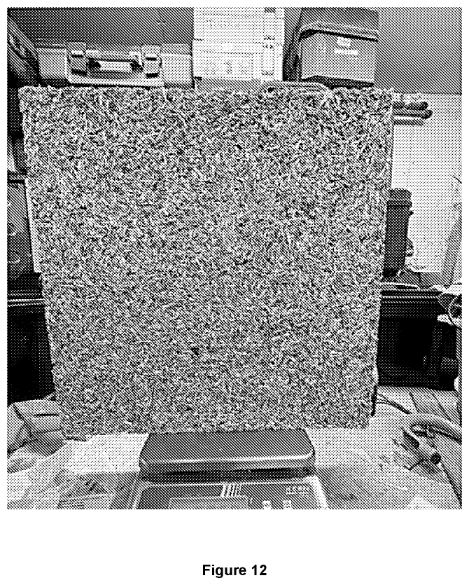

The specimen was weighed after being demoulded, and at a further two timepoints on the following two days (Table 11; and FIG. 12). After being demoulded the specimen was placed cast base up and dried with flowing air. Additionally, a ventilated weight was placed on top of the specimen to ensure it did not curl up during the drying process.

TABLE 11
Mass, moisture and density results of the hemp-silicate
formulation without reactant during the drying process.

| Time from | | | | |
|---|---|---|---|---|
| start of | | | Moisture | |
| process | | Mass | content | Density |
| (hrs) | Step | (g) | (%) | (kg/m³) |
| 0 | Composition mixed and | 4400 | 62 | NA |
| | transferred into the mould. | | | |
| 17 h 45 m | The top surface was left open | 4203 | 55 | NA |
| | overnight at 16° C., demoulded | | | |
| | and weighed. | | | |
| 41 h 10 m | The specimen was placed cast | 3059 | 12 | 236 |
| | base up and dried with flowing | | | |
| | air. A ventilated weight was | | | |
| | placed on top to ensure that it | | | |
| | did not curl up during drying. | | | |
| | The specimen was then weighed. | | | |
| 64 h 30 m | The drying process described | 3043 | 12 | 235 |
| | above was continued. The | | | |
| | specimen was then weighed. | | | |

The specimen was found to be fully equilibrated in under 24 hours after being demoulded.

The specimen benefited from being cheaper to manufacture than other formulations due to not using a reactant.

A benefit to this formulation is that it is reversible. Set sodium silicate (water glass) may be dissolved out of the composition and recovered; similarly, the remaining hemp shiv can be recovered via drying.

Other formulations may be preferable to ensure maintenance of structural integrity during high humidity or water exposure.

### Further Examples Based on Formulations 5-8 Above

1. A low-density composition in accordance with the present invention was prepared by use of minimal or no compaction or compression on moulding. This results in an insulation material with a dry density range of 150 kg/m³ to 300 kg/m³—typically 195 kg/m³. Thermal conductivity in the range of 0.065 to 0.085 Wm⁻¹K⁻¹. Compressive strength in the range of 0.1 to 0.2 MPa.
2. A higher density composition in accordance with the present invention was prepared by compressing with loads of between 100 and 200 kPa to create rigid render carrier boards with thicknesses ranging from 15 mm to 50 mm (typically 25 mm). Dry density range of 400 to 500 kg/m³—typically 450 kg/m³. Thermal conductivity in the range of 0.085 to 0.095 Wm⁻¹K⁻¹. Flexural strength in the range of 0.5 to 1.1 MPa
3. A high-density composite composition in accordance with the present invention was prepared by compressing with loads of up to 400 kPa lined with paper to create a plasterboard with thicknesses ranging from 8 mm to 20 mm (typically 12.5 mm). Typically using fine (<3 mm) hemp shiv. In order to improve surface smoothness the composite can comprise of a surface layer of 1-3 mm (between paper and shiv) of binder with an addition of 2.5% hydrogen peroxide (0.5% to 5%) which is allowed to set for 5 minutes before addition of bio-composite. This creates a smooth fire-resistant layer that resists penetration of the bio-composite when compressed.
4. A medium-density composition in accordance with the present invention was prepared by compressing with loads up to 400 kPa to produce composite building blocks with compressive strengths up to 1 MPa (typically 0.4 MPa) and dry densities of 300-500 kg/m³. (Typically 350 kg/m³). Compression times are expected to be as low as 1 minute prior to de-moulding.
5. A composition in accordance with the present invention comprising 90-100% binder reinforced with a render mesh, with the addition of 0.5% to 5%, suitably 2.5% hydrogen peroxide. This is laid onto paper and allowed to set and expand for up to 3 hours creating a fire-proof lightweight insulating board.

In all cases, the addition of hydrogen peroxide will accelerate set times and can be used to allow more rapid de-moulding, and hence faster production.

Although particular embodiments of the invention have been disclosed herein in detail, this has been done by way of example and for the purposes of illustration only. The aforementioned embodiments are not intended to be limiting with respect to the scope of the invention. It is contemplated by the inventors that various substitutions, alterations, and modifications may be made to the invention without departing from the spirit and scope of the invention.

1) A composition comprising:
a. a binder comprising a silicate; and
b. a bio-aggregate;
wherein the binder comprises at least 50% by weight of the silicate, based on the total weight of the binder.

2) The composition of claim 1, wherein the silicate is selected from the group consisting of: sodium silicate; potassium silicate and combinations thereof.

3) The composition of claim 1 or claim 2, wherein the silicate is sodium silicate.

4) The composition of any one of claims 1 to 3, wherein the bio-aggregate is selected from the group consisting of: hemp shiv; flax shiv; chopped sunflower stalk; chopped cereal straw; cork particles; corn cob particles; wood chip and mixtures thereof.

5) The composition of any one of claims 1 to 4, wherein the bio-aggregate is hemp shiv.

6) The composition of any one of claims 1 to 5, wherein the binder is present in an amount of from 5% to 95% by weight and the bio-aggregate is present in an amount of from 95% to 5% by weight, based on the total weight of the composition.

7) The composition of any one of claims 1 to 6, wherein the binder comprises at least 70% by weight of the silicate, based on the total weight of the binder.

8) The composition of any one of claims 1 to 7, wherein the binder comprises at least 85% by weight of the silicate, based on the total weight of the binder.

9) The composition of any one of claims 1 to 8, wherein the binder further comprises a reactant that chemically reacts with the silicate.

10) The composition of claim 9, wherein the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate.

11) The composition of claim 10, wherein the reactant is ethyl acetate or glycerol triacetate.

12) The composition of claim 9 to 11, wherein the binder comprises between 0.5 to 20% by weight of the reactant, based on the total weight of the binder.

13) The composition of any one of claims 9 to 12, wherein the binder comprises at least 70% by weight of the silicate and the reactant, based on the total weight of the binder.

14) The composition of any one of claims 9 to 12, wherein the binder comprises at least 85% by weight of the silicate and the reactant, based on the total weight of the binder.

15) The composition of any one of claims 1 to 14, wherein the binder further comprises an oxidising agent.

16) The composition of claim 15, wherein the oxidising agent is hydrogen peroxide.

17) The composition of claim 15 or claim 16, wherein the binder comprises between 0.5 to 15 wt % of the oxidising agent, based on the total weight of the binder.

18) The composition of any one of claims 1 to 17, wherein the binder further comprises a surfactant.

19) The composition of claim 18, wherein the surfactant is selected from the group consisting of: Sika® AER5 and alkyl sulfonate.

20) The composition of claim 18 or claim 19, wherein the binder comprises between 1 to 10 wt % of one or more of the surfactant, based on the total weight of the binder.

21) The composition of any one of claims 1 to 20, wherein the composition comprises between 0.1 to 20 wt % of one or more additives, based on the total weight of the composition.

22) The composition of any one of claims 1 to 21, wherein the composition is biodegradable.

23) The composition of any one of claims 1 to 22, wherein the binder has a carbon footprint of less than 20 kg CO₂e per cubic metre of composition.

24) A composition comprising:
a. a binder comprising sodium silicate, and a reactant selected from the group consisting of ethyl acetate and glycerol triacetate; and
b. a bio-aggregate;
wherein the binder comprises at least 50% by weight of the silicate, based on the total weight of the binder.

25) The composition of claim 24, wherein the reactant is glycerol triacetate.

26) A composition comprising:
a. a binder comprising:
i. a silicate;
ii. a reactant;
iii. an oxidising agent;
iv. a surfactant; and
b. a bio-aggregate;
wherein the binder comprises at least 50% by weight of the silicate, based on the total weight of the binder.

27) The composition of claim 26, wherein the silicate, the reactant, the oxidising agent and the surfactant in a weight ratio of approximately 100:7.5:2.5:4.

28) The composition of claim 26 or claim 27, wherein:
a. the silicate is sodium silicate;
b. the reactant is ethyl acetate or glycerol triacetate;
c. the oxidising agent is hydrogen peroxide; and/or
d. the surfactant is Sika® AER5 or alkyl sulfonate.

29) A silicate binder for use in the composition of claims 1 to 28, wherein the binder comprises at least 50% by weight of a silicate, based on the total weight of the binder.

30) The silicate binder of claim 29, wherein the binder comprises at least 70% by weight of the silicate, based on the total weight of the binder.

31) The silicate binder of claim 29, wherein the binder comprises at least 85% by weight of the silicate, based on the total weight of the binder.

32) The silicate binder of any one of claims 29 to 31, further comprising:
a. a reactant;
b. an oxidising agent; and/or
c. a surfactant

33) The silicate binder of claim 32, wherein:
a. the silicate is sodium silicate;
b. the reactant is ethyl acetate or glycerol triacetate;
c. the oxidising agent is hydrogen peroxide; and/or
d. the surfactant is Sika® AER5 or alkyl sulfonate.

34) A product comprising:
a. A binder of any one of claims 29 to 33;
b. A reinforcement component.

35) The product of claim 34, wherein the product is a lightweight insulating board product.

36) The product of claim 34 or claim 35, wherein the reinforcement component is selected from the group consisting of: woven fibres; non-woven fibres; mesh sheet; and rods.

37) The product of claim 36, wherein the reinforcement component is a mesh reinforcement sheet.

38) The product of any one of claims 34 to 37, wherein the reinforcement component is embedded within and/or is on the surface of the product.

39) The product of any one of claims 34 to 38, further comprising:
c. Lining on at least one face of the product.

40) The product of any one of claims 34 to 39, wherein the lining is formed of paper.

41) The product of any one of claims 34 to 40, wherein the board product comprises one or more layers of binder.

42) The product of any one of claims 34 to 41, wherein the board product further comprises up to 10 wt % bio-aggregate, based on the total weight of the product.

43) The product of any one of claims 34 to 42, wherein the oxidising agent is present in an amount of approximately 0.5 wt % to approximately 5 wt %, based on the total weight of the binder.

44) A method of preparing the composition of any one of claims 1 to 28, said method comprising the steps of:
a. combining a binder comprising a silicate, a bio-aggregate to provide a slurry;
b. mixing the slurry to provide a mixture;
c. allowing the mixture to set to provide the composition.
wherein the binder comprises at least 50% by weight of the silicate, based on the total weight of the binder.

45) The method of claim 44, wherein the silicate is selected from the group consisting of: sodium silicate potassium silicate and combinations thereof.

46) The method of claim 44 or claim 45, wherein the silicate is sodium silicate.

47) The method of any one of claims 44 to 46, wherein the bio-aggregate is selected from the group consisting of: hemp shiv flax shiv; chopped sunflower stalk; chopped cereal straw; cork particles; corn cob particles; wood chip and mixtures thereof.

48) The method of any one of claims 44 to 47, wherein the bio-aggregate is hemp shiv.

49) The method of any one of claims 44 to 48, wherein the binder is present in an amount of from 5% to 95% by weight and the bio-aggregate is present in an amount of from 95% to 5% by weight, based on the total weight of the composition.

50) The method of any one of claims 44 to 49, wherein the binder comprises at least 70% by weight of the silicate, based on the total weight of the binder.

51) The method of any one of claims 44 to 50, wherein the binder comprises at least 85% by weight of the silicate, based on the total weight of the binder.

52) The method of any one of claims 44 to 51, wherein the binder further comprises a reactant that chemically reacts with the silicate.

53) The method of claim 52, wherein the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate.

54) The method of claim 53, wherein the reactant is ethyl acetate or glycerol triacetate.

55) The method of any one of claims 44 to 54, wherein the binder comprises between 0.5 to 20% by weight of the reactant, based on the total weight of the binder.

56) The method of any one of claims 52 to 55, wherein the binder comprises at least 70% by weight of the silicate and the reactant, based on the total weight of the binder.

57) The method of any one of claims 52 to 56, wherein the binder comprises at least 85% by weight of the silicate and the reactant, based on the total weight of the binder.

58) The method of any one of claims 44 to 57, wherein the binder further comprises an oxidising agent.

59) The method of claim 58, wherein the oxidising agent is hydrogen peroxide.

60) The method of claim 58 or claim 59, wherein the binder comprises between 0.5 to 15 wt % of one or more of the oxidising agent, based on the total weight of the binder.

61) The method of any one of claims 58 to 60, wherein the binder further comprises a surfactant.

62) The method of claim 61, wherein the surfactant is selected from the group consisting of: Sika® AER5 and alkyl sulfonate.

63) The method of claim 61 or claim 62, wherein the binder comprises between 1 to 10 wt % of one or more of the surfactant, based on the total weight of the binder.

64) The method of any one of claims 44 to 63, wherein after step (c) the method comprises:
d) de-watering the composition.

65) The method of claim 64, wherein the de-watering in step (d) is by forcing air through the composition.

66) The method of claim 64 or claim 65, wherein de-watering is complete within 12 hours to 48 hours.

67) The method of any one of claim 64 to 66, wherein carbon dioxide is fed to the composition during drying.

68) The method of any one of claim 64 to 67, wherein after de-watering the composition is cured at elevated temperature.

69) The method of claim 68, wherein the elevated temperature is between 80° C. to 200° C.

70) The method of any one of claims 64 to 69 wherein the mixture is compressed prior to, or during, setting in step (c).

71) The method of claim 70, wherein the mixture is compressed at a pressure of between 200 kPa to 500 kPa.

72) The method of claim 70 or claim 71, wherein the composition is compressed for between 1 minute and 8 hours.

73) A method of preparing the silicate binder of any one of claims 29 to 33, said method comprising the steps of:
a. providing a binder comprising a silicate as a slurry;
b. mixing the slurry to provide a mixture;
c. allowing the mixture to set to provide the silicate binder.
wherein the binder comprises at least 50% by weight of the silicate, based on the total weight of the binder.

74) The method of claim 73, wherein the silicate is selected from the group consisting of: sodium silicate potassium silicate and combinations thereof.

75) The method of claim 73 or claim 74, wherein the silicate is sodium silicate.

76) The method of any one of claims 73 to 75, wherein the binder comprises at least 70% by weight of the silicate, based on the total weight of the binder.

77) The method of any one of claims 73 to 76, wherein the binder comprises at least 85% by weight of the silicate, based on the total weight of the binder.

78) The method of any one of claims 73 to 75, wherein the binder further comprises a reactant that chemically reacts with the silicate.

79) The method of any one of claims 73 to 78, wherein the reactant is selected from the group consisting of: carbon dioxide; carbonic acid; calcium chloride; magnesium chloride; magnesium carbonate; magnesium sulfate; aluminium sulfate; formamide (2%-10%); sodium bicarbonate; sodium aluminate; glyoxal; ethyl acetate; and glycerol triacetate.

80) The method of claim 79, wherein the reactant is ethyl acetate or glycerol triacetate.

81) The method of any one of claims 76 to 80, wherein the binder comprises between 0.5 to 20% by weight of the reactant, based on the total weight of the binder.

82) The method of any one of claims 73 to 81, wherein the binder comprises at least 70% by weight of the silicate and the reactant, based on the total weight of the binder.

83) The method of any one of claims 73 to 82, wherein the binder comprises at least 85% by weight of the silicate and the reactant, based on the total weight of the binder.

84) The method of any one of claims 73 to 83, wherein the binder further comprises an oxidising agent.

85) The method of claim 84, wherein the oxidising agent is hydrogen peroxide.

86) The method of claim 84 or claim 85, wherein the binder comprises between 0.5 to 15 wt % of one or more of the oxidising agent, based on the total weight of the binder.

87) The method of any one of claims 78 to 86, wherein the binder further comprises a surfactant.

88) The method of claim 87, wherein the surfactant is selected from the group consisting of: Sika® AER5 and alkyl sulfonate.

89) The method of claim 87 or claim 88, wherein the binder comprises between 1 to 10 wt % of one or more of the surfactant, based on the total weight of the binder.

90) The method of any one of claims 73 to 89, wherein after step (c) the method comprises:
d) de-watering the silicate binder.

91) A product formed of the composition of claims 1 to 28, the silicate binder of claims 29 to 33 or by the method of claims 40 to 90.

92) The product of claim 91, wherein the product is selected from the group consisting of: insulation block; insulation panel; sheet material; board; and cladding.

93) The product of claim 91 or claim 92, wherein the product has an outer layer of sheet material on at least one surface.

94) The product of claim 93 wherein the sheet material is selected from the group consisting of: paper; hessian; cloth; woven fabric; non-woven fabric; and bio-based mesh.

95) Use of the composition of claims 1 to 28, the silicate binder of claims 29 to 33 or the product of claims 91 to 94 in construction.

96) Use of the composition of claims 1 to 28, the silicate binder of claims 29 to 33 or the product of claims 91 to 94 as an insulation material.

97) Use of the composition of claims 1 to 28, the silicate binder of claims 29 to 33 or the product of claims 91 to 94 as an insulation block.

98) Use of the composition of claims 1 to 28, the silicate binder of claims 29 to 33 or the product of claims 91 to 94 as a wall board.

99) The use of claim 98, wherein the wall board is selected from the group consisting of: a render carrier; and plasterboard.
